(19) United States
(12) Patent Application Publication
(10) Pub. No.: US 2023/0376878 A1
(43) Pub. Date: Nov. 23, 2023

(54) METHOD OF MEASURING HOW EFFECTIVE A TEAM IS AS WELL AS HOW EFFECTIVE THE LEADER OF THAT TEAM IS

(71) Applicants: Renée Safrata, West Vancouver (CA); James Sellner, West Vancouver (CA)

(72) Inventors: Renée Safrata, West Vancouver (CA); James Sellner, West Vancouver (CA)

(21) Appl. No.: 18/162,804

(22) Filed: Feb. 1, 2023

Related U.S. Application Data
(60) Provisional application No. 63/337,635, filed on May 3, 2022.
(60) Provisional application No. 63/310,748, filed on Feb. 16, 2022.

(51) Int. Cl. G06Q 10/0639; G06Q 10/0637

(52) U.S. Cl. CPC G06Q 10/06393; G06Q 10/06398; G06Q 10/06375

(57) ABSTRACT

The invention relates to applying an anonymous interactive behavioral analytic process that allows teams to measure how the interactions between team members' interactive behaviors in six key indicators including, communication, accountability, feedback, emotional intelligence, structures, and cohesion. This method is configured to determine the effectiveness of the team which is measured by a team effectiveness score and a measure of the monetary cost of lost productivity. The invention also relates to a method of gauging productivity within an organization and more particularly estimating the financial performance of the organization based on the employee and management efficiency and work methods.

### CROSS-REFERENCE TO RELATED APPLICATIONS

This application claims the benefit of U.S. Provisional Patent Application No. 63/337,635, filed on May 3, 2022, which in turn claims the benefit of U.S. Provisional Patent Application No. 63/310,748, filed on Feb. 16, 2022, both of which are incorporated by reference herein in their entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The instant invention relates to the field of interactive behavioral analytic process.

### 2) Description of Related Art

Currently the state of the art includes a number of products in the market place that attempt to measure the return on investment (ROI) of team and leadership development. In particular, there is a need for a solution to at least one of the problems described.

### BRIEF SUMMARY OF THE INVENTION

The instant invention in one form is directed to identifying and analyzing the hidden sunk costs of teams and leaders. That is, the ways a company is wasting their money and disengaging their people. Most companies don't measure sunk costs. For example, companies spend an enormous amount of money paying people to sit in meetings over the course of a typical month or year, but they do not run a calculation of how efficient or effective those meetings are. Additionally, people are not trained well to participate in or run effective, efficient meetings. Instead, they'll spend costly hours in meetings strategizing, for example, on how to get the best deal on screen sharing.

The decision to ignore and not measure such costs leads to the “sunk cost fallacy.” These costs are not recorded anywhere in the budget and seem to not exist. But they very much do have a real cost. It is like a leaking underground water pipe. You can't see it but its wasting water nonetheless. Economists consider payments, investments, or costs which can never be recovered as sunk costs. When looking for ways to manage costs, managers and executives are trained to ignore money already spent in the past, which is gone and can never be recovered. They focus instead on how money can be spent going forward. When it comes to tracking the cost and value of meetings (Structures in Vivo Team's VSR), managers will dismiss the cost of people's time as one of these sunk costs because they've already committed to paying salaries. The decision to spend salary dollars is in the past—done, over, and can't be undone without major disruption to the organization and here's where that thinking fails: while you may have decided to spend salary dollars in the past, you're actually spending them RIGHT NOW and every day going forward that you keep that person involved in your team.

In some aspects, the techniques described herein relate to a computer program including instructions which, when the program is executed by a computer, cause the computer to carry out the steps including of: calculating, using the computer program, a baseline cost of lost productivity of a team; providing a training program for the team having a leader to participate, including: a vital statistics report, using the computer program, the vital statistics report having a key indicator; and a statement, using the vital statistics report, is displayed to the team, wherein the statement is associated with the key indicator, wherein the team responds with a response to the statement, the response forms a score; computing the score, using machine learning, to calculate a measured cost of lost productivity of the team; and comparing the baseline cost of the lost productivity of the team to the measured cost of the lost productivity of the team, using the computer program, to generate a team effectiveness score based on detected behavioral changes that determine effectiveness of the team.

In some aspects, the techniques described herein relate to a computer program wherein, the key indicator is communication.

In some aspects, the techniques described herein relate to a computer program wherein, the key indicator is accountability.

In some aspects, the techniques described herein relate to a computer program wherein, the key indicator is interactive feedback.

In some aspects, the techniques described herein relate to a computer program wherein, the key indicator is emotional intelligence.

In some aspects, the techniques described herein relate to a computer program wherein, the key indicator is structures.

In some aspects, the techniques described herein relate to a computer program wherein, the key indicator is cohesion.

In some aspects, the techniques described herein relate to a computer program wherein, the statement being competency based.

In some aspects, the techniques described herein relate to a computer program wherein, the statement being motivation based.

In some aspects, the techniques described herein relate to a computer program wherein, the statement being collaboration based.

In some aspects, the techniques described herein relate to a computer program wherein, the baseline cost is determined before a training session begins during diagnosis.

In some aspects, the techniques described herein relate to a computer program wherein, the training program uses a spaced learning model having a plurality of training sessions with at least one interval of no learning.

In some aspects, the techniques described herein relate to a computer program further including the training program uses analytics being a data set that describes a meaningful pattern of human behavior in the team having the leader, wherein predicting of probable consequences and prescribing of a solution to a potentially negative behavior is performed during the training program.

In some aspects, the techniques described herein relate to a computer program wherein, the team effectiveness score and a measure of the cost of the lost productivity is represented in a monetary value, using the computer program.

These and other important objects, advantages, and features of the invention will become clear as this description proceeds.

### BRIEF DESCRIPTION OF THE DRAWINGS

These and other objects, features, and advantages of the present invention will become more readily apparent from the attached drawings and the detailed description of the preferred embodiments, which follow.

FIG. 1 is an illustration of a device showing an operational sequence that may be performed when running a Vital Statistics Report software;

FIG. 2 is an illustration of a device showing an operational sequence that may be performed when running a Vital Statistics Report software;

FIG. 3 is an illustration of a device showing an operational sequence that may be performed when running a Vital Statistics Report software;

FIG. 4 is an illustration of a device showing an operational sequence that may be performed when running a Vital Statistics Report software;

FIG. 5 is an illustration of a device showing an operational sequence that may be performed when running a Vital Statistics Report software;

FIG. 6 is an illustration of a device showing an operational sequence that may be performed when running a Vital Statistics Report software;

FIG. 7 is an illustration of a device showing an operational sequence that may be performed when running a Vital Statistics Report software;

FIG. 8 is an illustration of a device showing an operational sequence that may be performed when running a Vital Statistics Report software;

FIG. 9 is an illustration of a device showing an operational sequence that may be performed when running a Vital Statistics Report software;

FIG. 10 is an illustration of a device showing an operational sequence that may be performed when running a Vital Statistics Report software;

FIG. 11 is an illustration of a device showing an operational sequence that may be performed when running a Vital Statistics Report software;

FIG. 12 is an illustration of a device showing an operational sequence that may be performed when running a Vital Statistics Report software;

FIG. 13 is an illustration of a device showing an operational sequence that may be performed when running a Vital Statistics Report software;

FIG. 14 is an illustration of a device showing an operational sequence that may be performed when running a Vital Statistics Report software;

FIG. 15 is an illustration of a device showing an operational sequence that may be performed when running a Vital Statistics Report software;

FIG. 16 is an illustration of a device showing an operational sequence that may be performed when running a Vital Statistics Report software;

FIG. 17 is an illustration of a device showing an operational sequence that may be performed when running a Vital Statistics Report software;

FIG. 18 is an illustration of a device showing an operational sequence that may be performed when running a Vital Statistics Report software;

FIG. 19 is an illustration of a device showing an operational sequence that may be performed when running a Vital Statistics Report software;

FIG. 20 is an illustration of a device showing an operational sequence that may be performed when running a Vital Statistics Report software;

FIG. 21 is an illustration of a device showing an operational sequence that may be performed when running a Vital Statistics Report software;

FIG. 22 is an illustration of a device showing an operational sequence that may be performed when running a Vital Statistics Report software;

FIG. 23 is an illustration of a device showing an operational sequence that may be performed when running a Vital Statistics Report software;

FIG. 24 is an illustration of a device showing an operational sequence that may be performed when running a Vital Statistics Report software;

FIG. 25 is an illustration of a device showing an operational sequence that may be performed when running a Vital Statistics Report software;

FIG. 26 is an illustration of a device showing an operational sequence that may be performed when running a Vital Statistics Report software;

FIG. 27 is an illustration of a device showing an operational sequence that may be performed when running a Vital Statistics Report software;

FIG. 28 is an illustration of a device showing an operational sequence that may be performed when running a Vital Statistics Report software;

FIG. 29A is the first portion of a flow chart and schematics of the team development and coaching method depicting the user interface with manager and client video interactions;

FIG. 29B is a second portion of the flow chart and schematics of the team development and coaching method depicting the user interface with manager and client video interactions;

FIG. 29C is a third portion of the flow chart and schematics of the team development and coaching method depicting the user interface with manager and client video interactions;

FIG. 29D is a fourth portion of the flow chart and schematics of the team development and coaching method depicting the user interface with manager and client video interactions; and

FIG. 30 is a flow chart illustrating method 3000 for a computer program comprising instructions.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

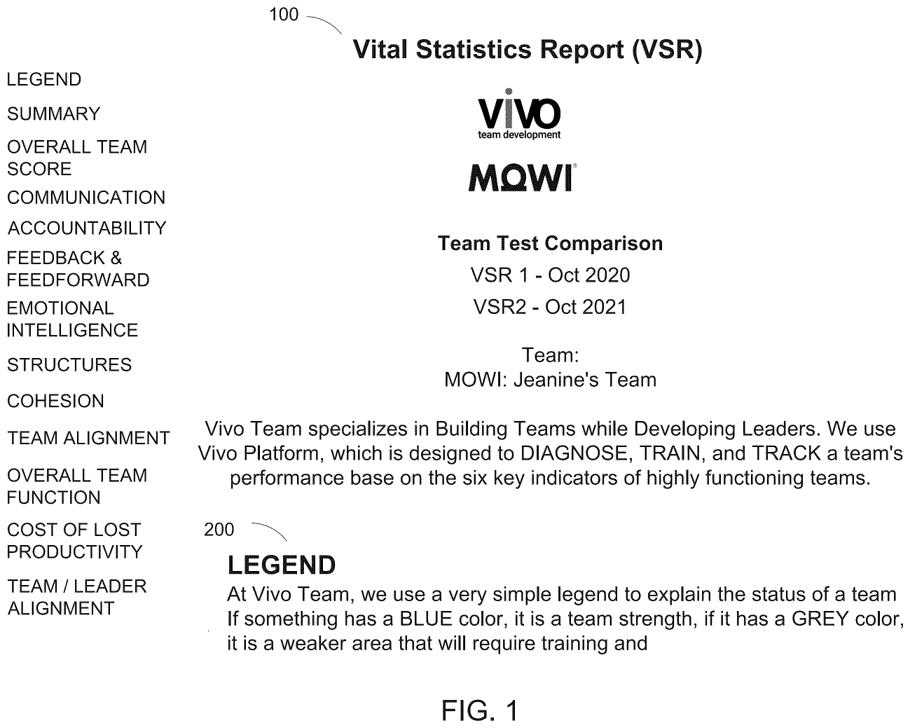

FIG. 1 is an illustration of a device showing operational sequence 100 that may be performed when running a Vital Statistics Report software. Legend 102 describes the team status.

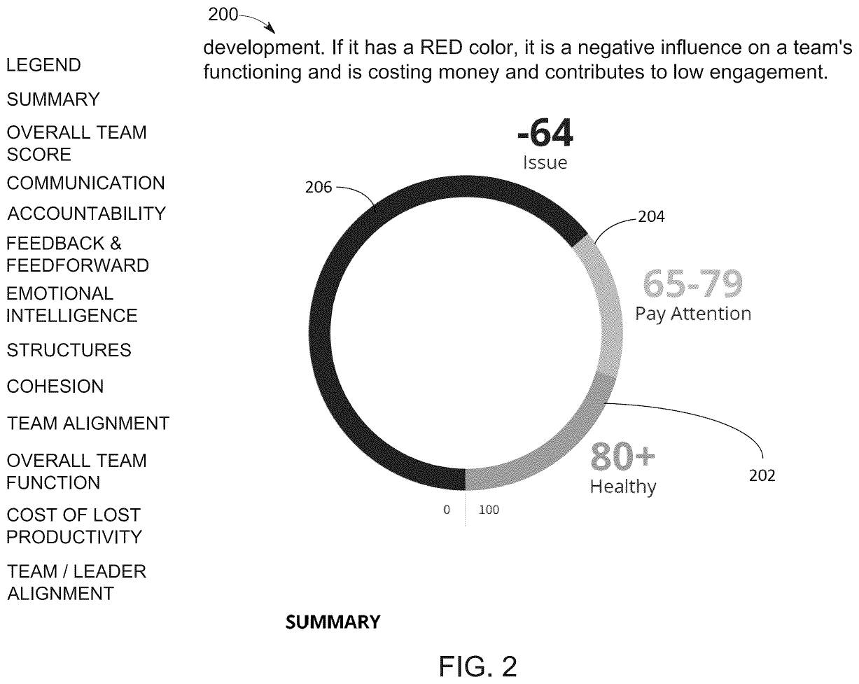

FIG. 2 is an illustration of a device showing operational sequence 200 that may be performed when running a Vital Statistics Report software. Blue color 202 corresponds to a team strength. Grey color 204 corresponds to a weaker area that will require training. Red color 206 indicates a negative influence has been detected on a team's functioning. Red color 206 is associated with costing money and contribution to low engagement. There is shown a typical Vital Statistics Report produced by the instant invention and typical questions, Number in red color 206.

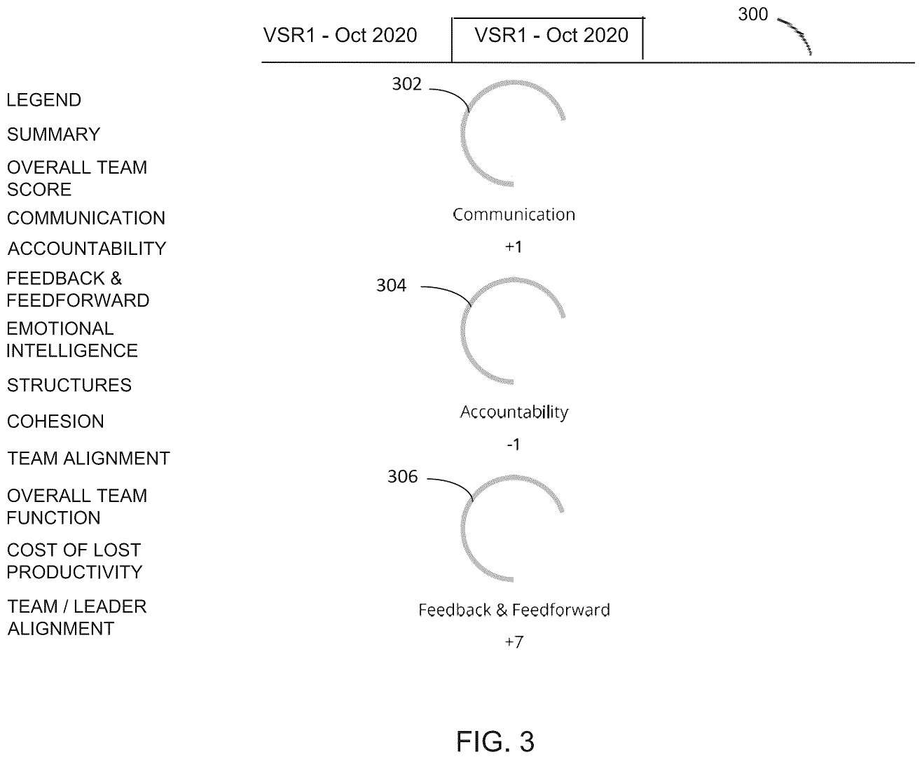

FIG. 3 is an illustration of a device showing operational sequence 300 that may be performed when running a Vital Statistics Report software. Key indicators shown are communication 302, accountability 304, and feedback and feedforward 306.

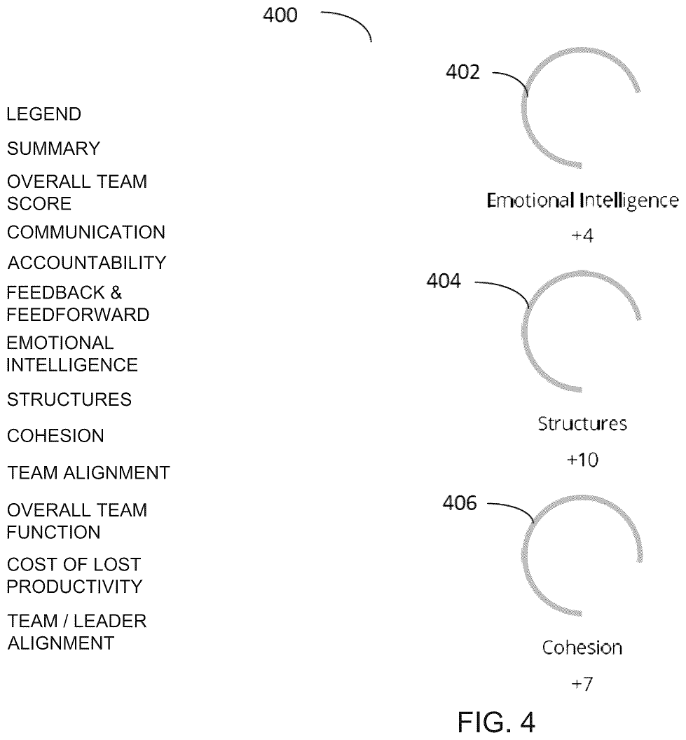

FIG. 4 is an illustration of a device showing operational sequence 400 that may be performed when running a Vital Statistics Report software. Key indicators shown are emotional intelligence 402, structures 404, and cohesion 406.

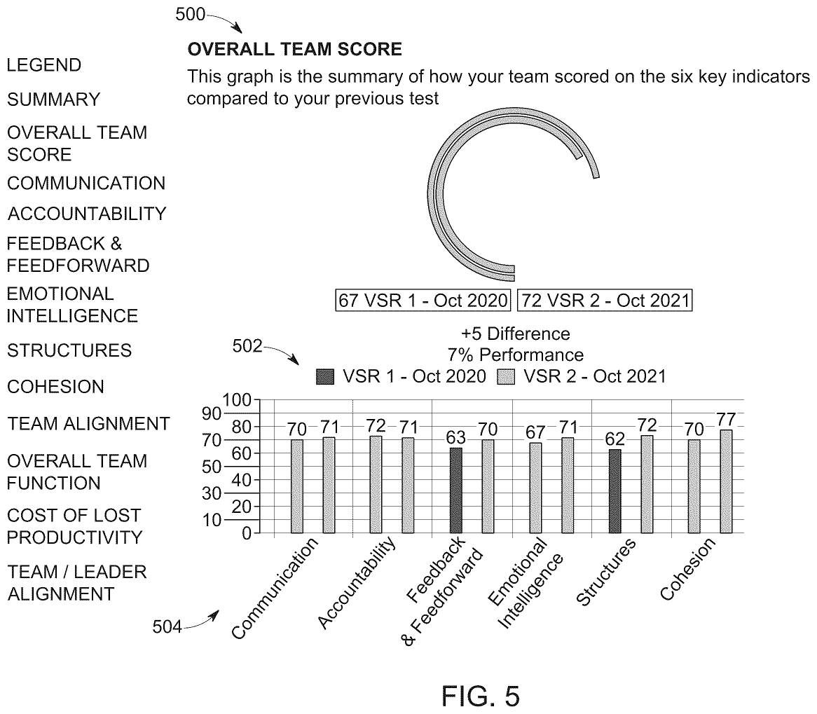

FIG. 5 is an illustration of a device showing operational sequence 500 that may be performed when running a Vital Statistics Report software. Graph 502 summarizes the overall team score of the six key indicators 504 compared to a previous test.

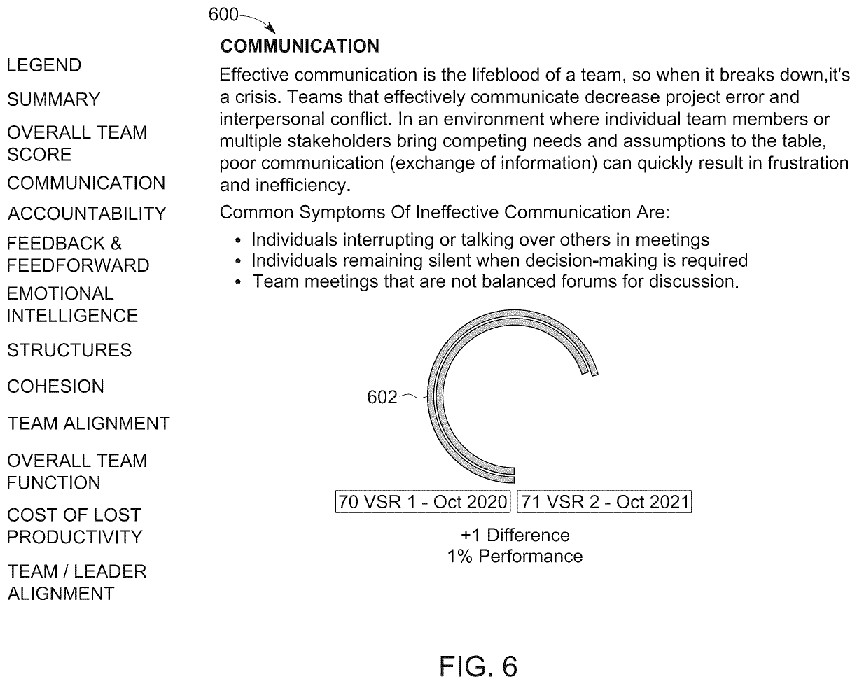

FIG. 6 is an illustration of a device showing operational sequence 600 that may be performed when running a Vital Statistics Report software. Effective communication is a critical element of a team. A crisis may occur when effective communication is compromised and breaks down. When a team effectively communicates, project error and interpersonal conflict decrease. In an environment where individual team members or multiple stakeholders bring competing needs and assumptions to the table, poor communication and/or exchange of information may quickly result in frustration and inefficiency. At 602, communication graph shows that in October 2020, the vital statistics report score was 70 and in October 2021, the vital statistics score was 71. This is a +1 difference having a 1% performance gain.

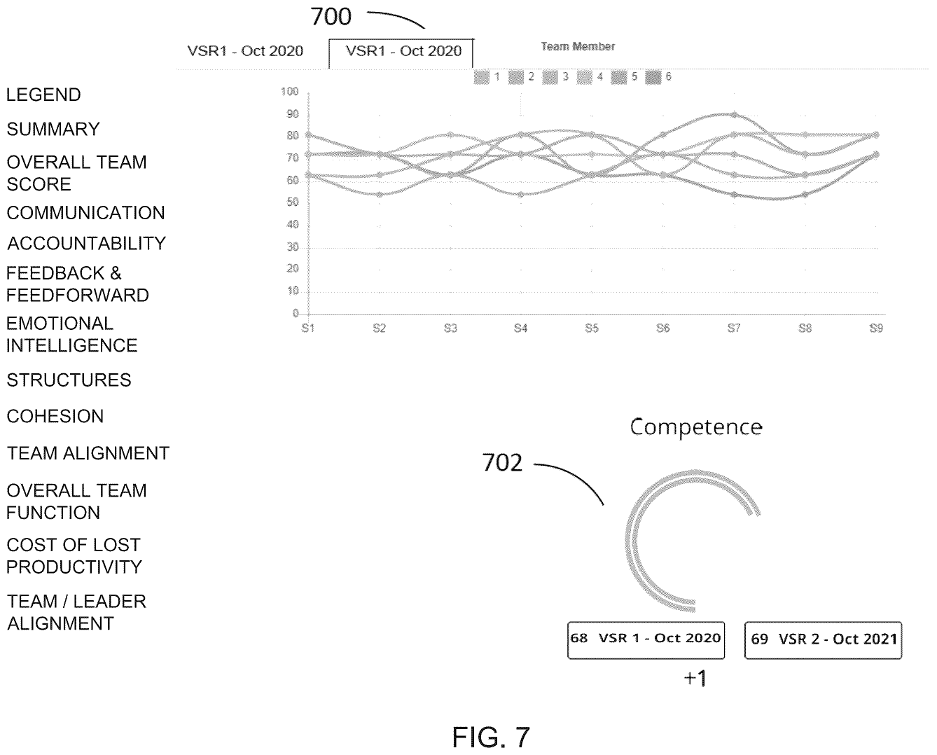

FIG. 7 is an illustration of a device showing operational sequence 700 that may be performed when running a Vital Statistics Report software. At 702, competence graph shows that in October 2020, the vital statistics report score was 68 and in October 2021, the vital statistics score was 69. This is a +1 difference having a 1% performance gain.

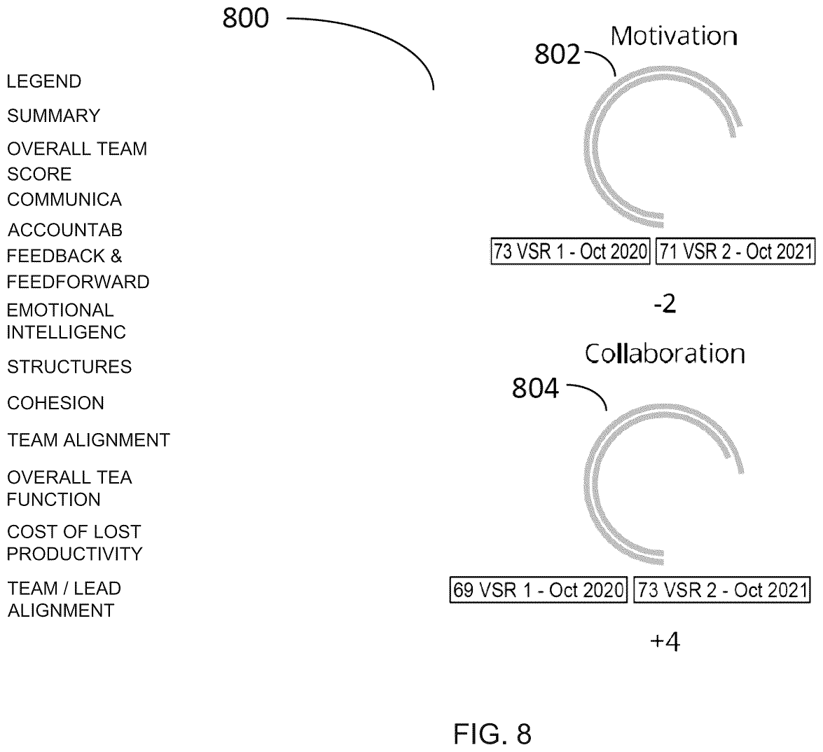

FIG. 8 is an illustration of a device showing operational sequence 800 that may be performed when running a Vital Statistics Report software. At 802, motivation graph shows that in October 2020, the vital statistics report score was 73 and in October 2021, the vital statistics score was 71. This is a −2 difference having a measurable performance loss. At 804, collaboration graph shows that in October 2020, the vital statistics report score was 69 and in October 2021, the vital statistics score was 73. This is a +4 difference having a measurable performance gain.

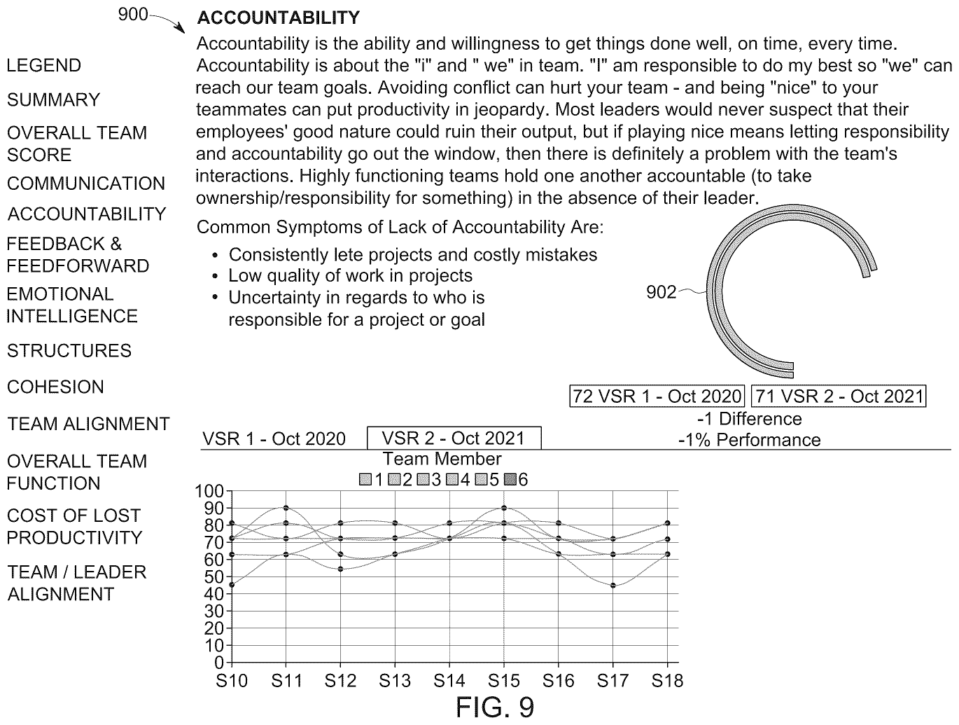

FIG. 9 is an illustration of a device showing operational sequence 900 that may be performed when running a Vital Statistics Report software. Accountability is the ability and willingness to complete a task on time. Common symptoms of having a lack of accountability include, but are not limited to, consistently having late projects, making costly mistakes, producing a low quality work product, and/or having uncertainty in regards to project and/or goal responsibility. At 902, accountability graph shows that in October 2020, the vital statistics report score was 72 and in October 2021, the vital statistics score was 71. This is a −1 difference having a measurable performance loss of −1%.

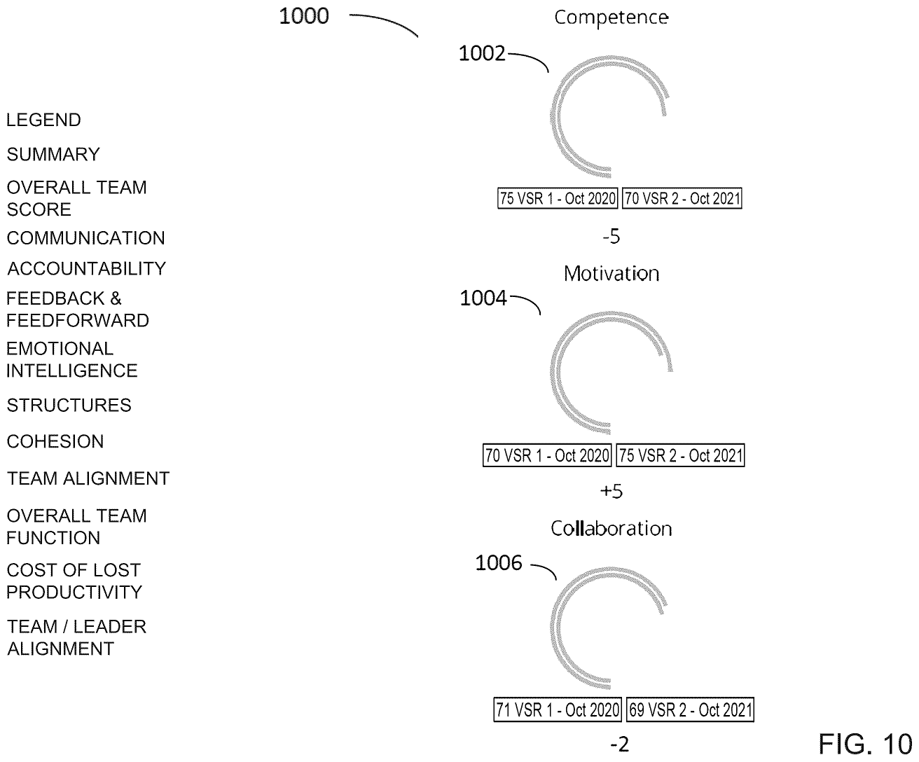

FIG. 10 is an illustration of a device showing operational sequence 1000 that may be performed when running a Vital Statistics Report software. At 1002, competence graph shows that in October 2020, the vital statistics report score was 75 and in October 2021, the vital statistics score was 70. This is a −5 difference having a measurable performance loss. At 1004, motivation graph shows that in October 2020, the vital statistics report score was 70 and in October 2021, the vital statistics score was 75. This is a +5 difference having a measurable performance gain. At 1006, collaboration graph shows that in October 2020, the vital statistics report score was 71 and in October 2021, the vital statistics score was 69. This is a −2 difference having a measurable performance loss

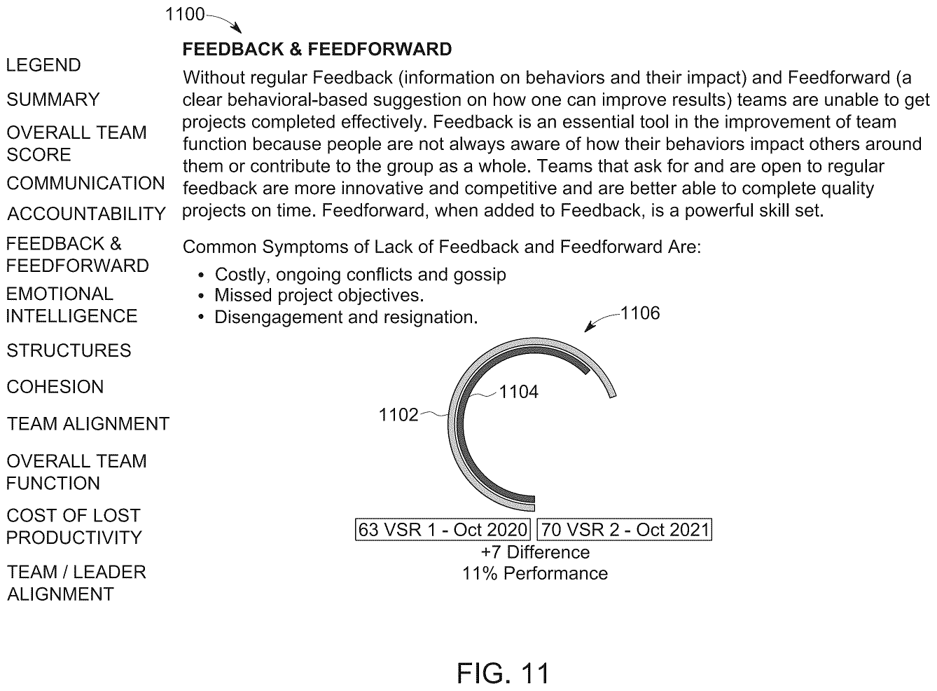

FIG. 11 is an illustration of a device showing operational sequence 1100 that may be performed when running a Vital Statistics Report software. Key indicator feedback and feedforward graph 1106 has grey color 1102 corresponding to a weaker area that will require training. Red color 1104 indicates a negative influence has been detected on a team's functioning.

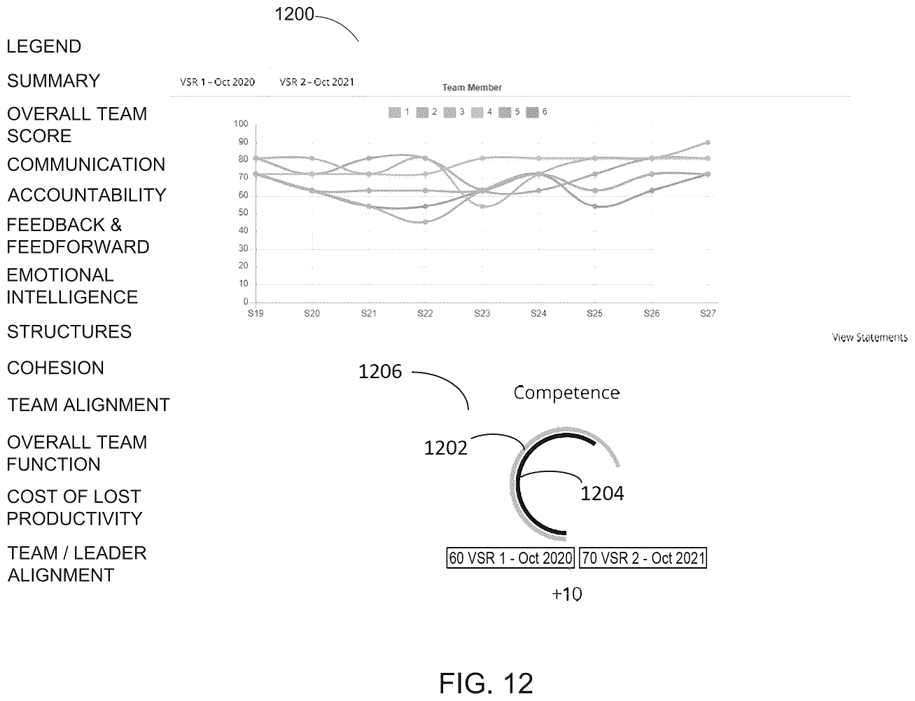

FIG. 12 is an illustration of a device showing operational sequence 1200 that may be performed when running a Vital Statistics Report software. Competence graph 1206 has grey color 1202 corresponding to a weaker area that will require training. Red color 1204 indicates a negative influence has been detected on a team's functioning.

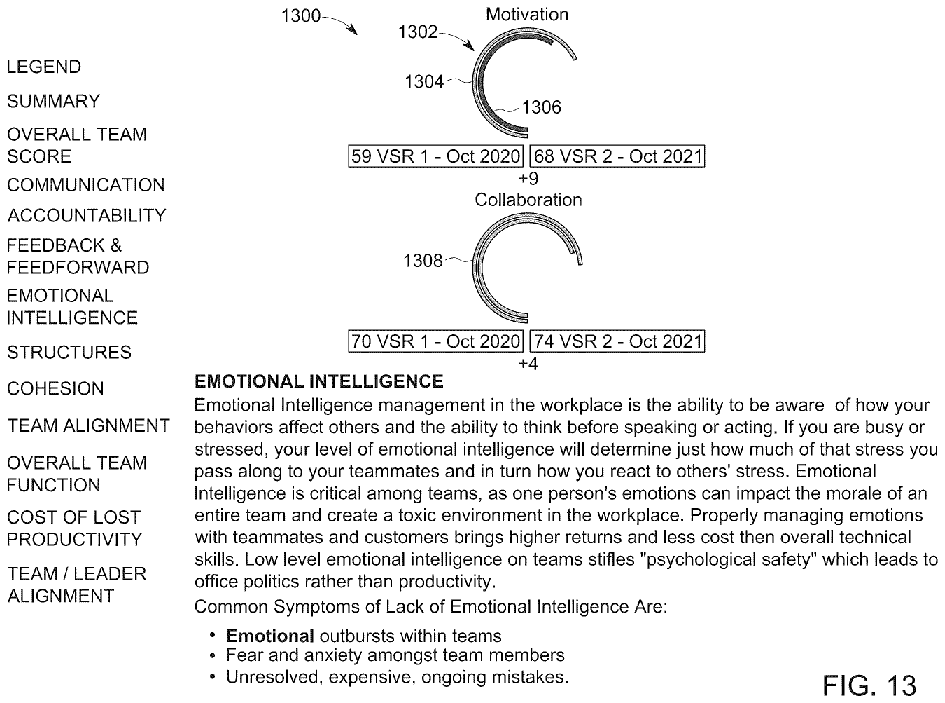

FIG. 13 is an illustration of a device showing operational sequence 1300 that may be performed when running a Vital Statistics Report software. Motivation graph 1302 has grey color 1304 corresponding to a weaker area that will require training. Red color 1306 indicates a negative influence has been detected on a team's functioning. Collaboration graph 1308 is shown to have a score of +4.

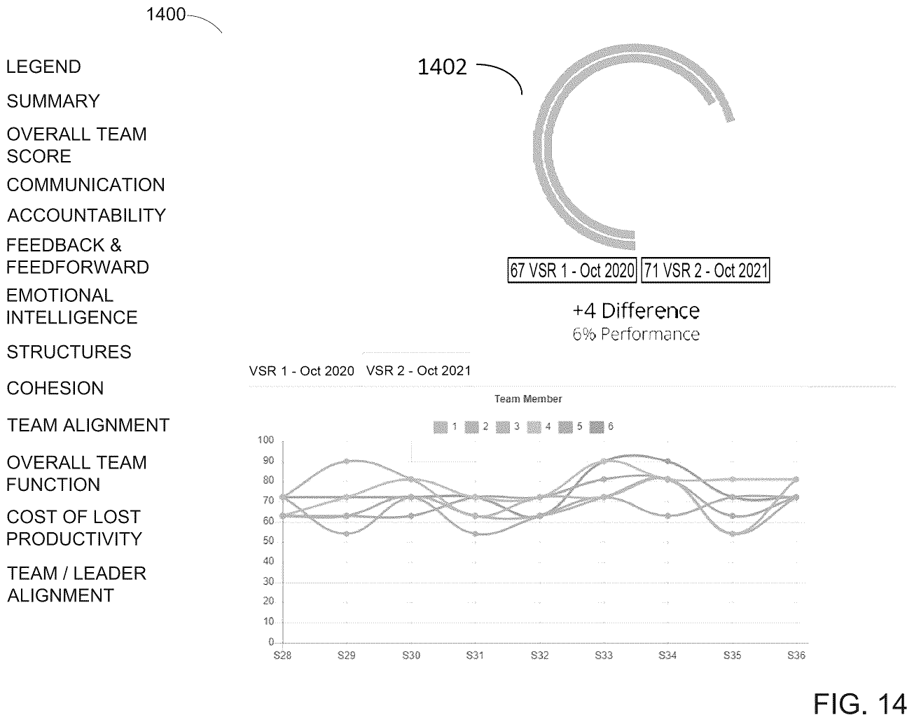

FIG. 14 is an illustration of a device showing operational sequence 1400 that may be performed when running a Vital Statistics Report software. Emotional intelligence graph 1402 is shown to have a score of +4.

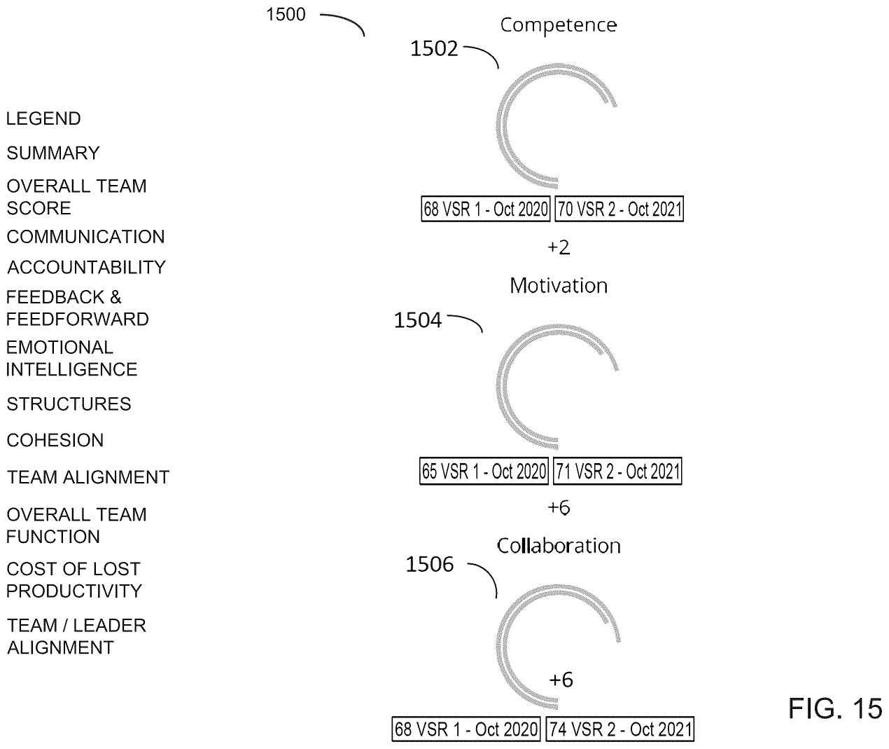

FIG. 15 is an illustration of a device showing operational sequence 1500 that may be performed when running a Vital Statistics Report software. Competence graph 1502 is shown to have a score of +2. Motivation graph 1504 is shown to have a score of +6. Collaboration graph 1506 is shown to have a score of +6.

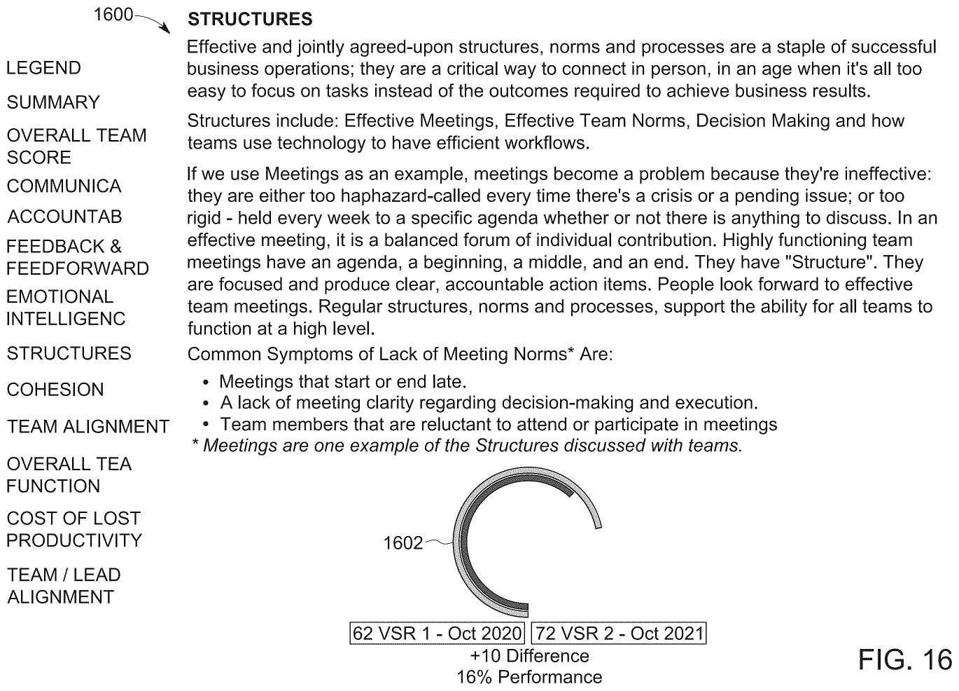

FIG. 16 is an illustration of a device showing operational sequence 1600 that may be performed when running a Vital Statistics Report software. Structures graph 1602 is shown to have a score of +10.

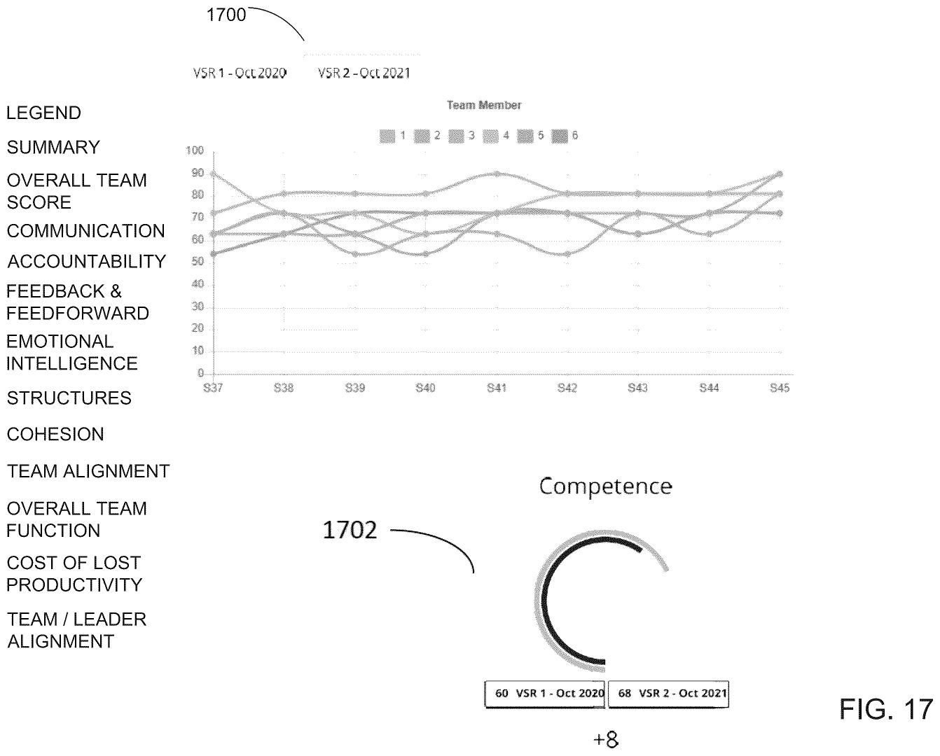

FIG. 17 is an illustration of a device showing operational sequence 1700 that may be performed when running a Vital Statistics Report software. Competence graph 1702 is shown to have a score of +8.

FIG. 17 is an illustration of a device showing operational sequence 1700 that may be performed when running a Vital Statistics Report software. Competence graph 1702 is shown to have a score of +8.

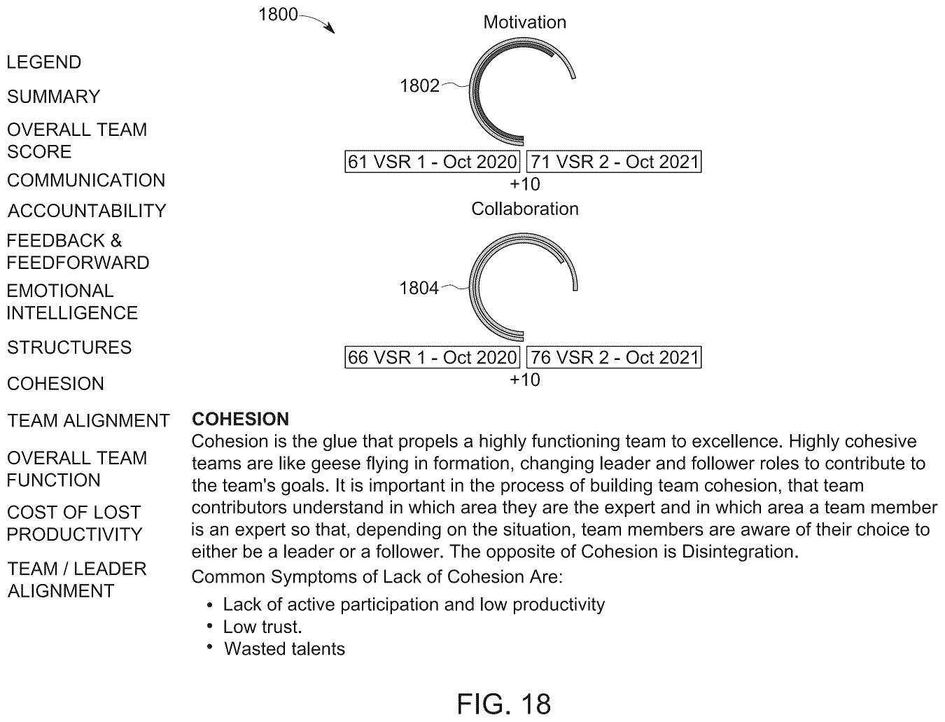

FIG. 18 is an illustration of a device showing operational sequence 1800 that may be performed when running a Vital Statistics Report software. Motivation graph 1802 is shown to have a score of +10. Collaboration graph 1804 is shown to have a score of +10.

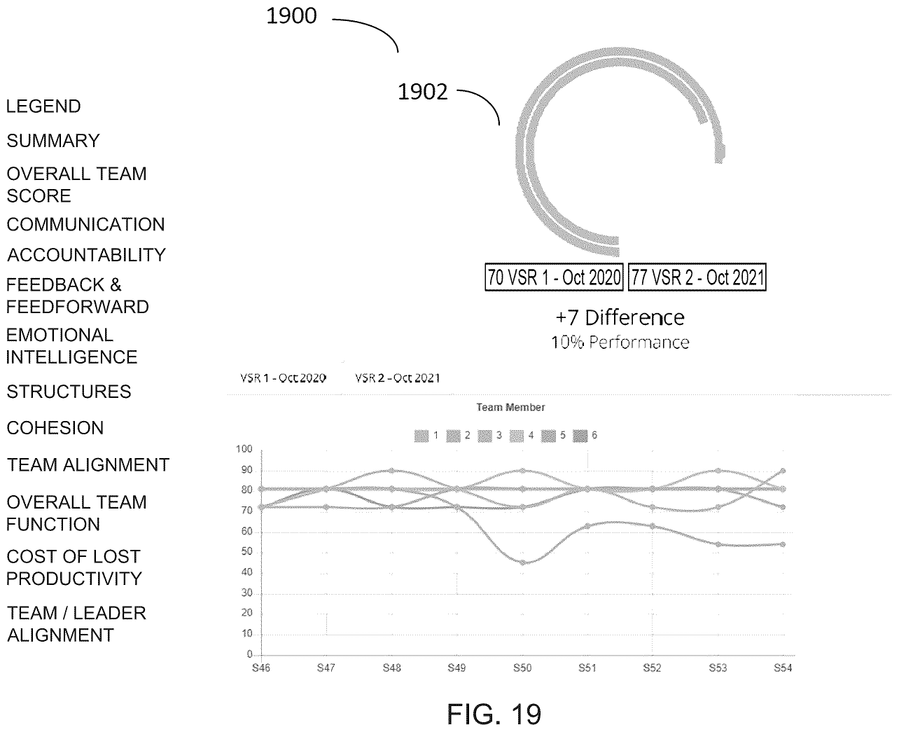

FIG. 19 is an illustration of a device showing operational sequence 1900 that may be performed when running a Vital Statistics Report software. Cohesion graph 1902 is shown to have a score of +7.

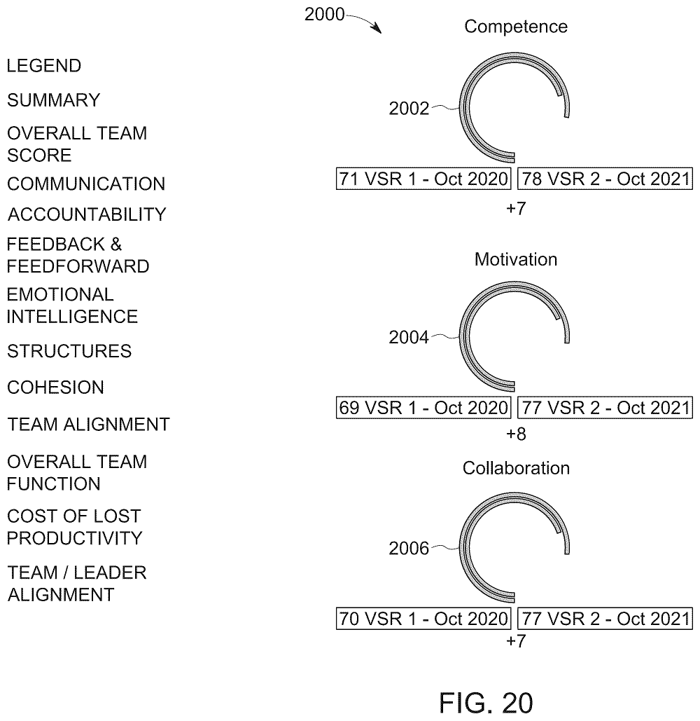

FIG. 20 is an illustration of a device showing operational sequence 2000 that may be performed when running a Vital Statistics Report software. Competence graph 2002 is shown to have a score of +7. Motivation graph 2004 is shown to have a score of +8. Collaboration graph 2006 is shown to have a score of +7.

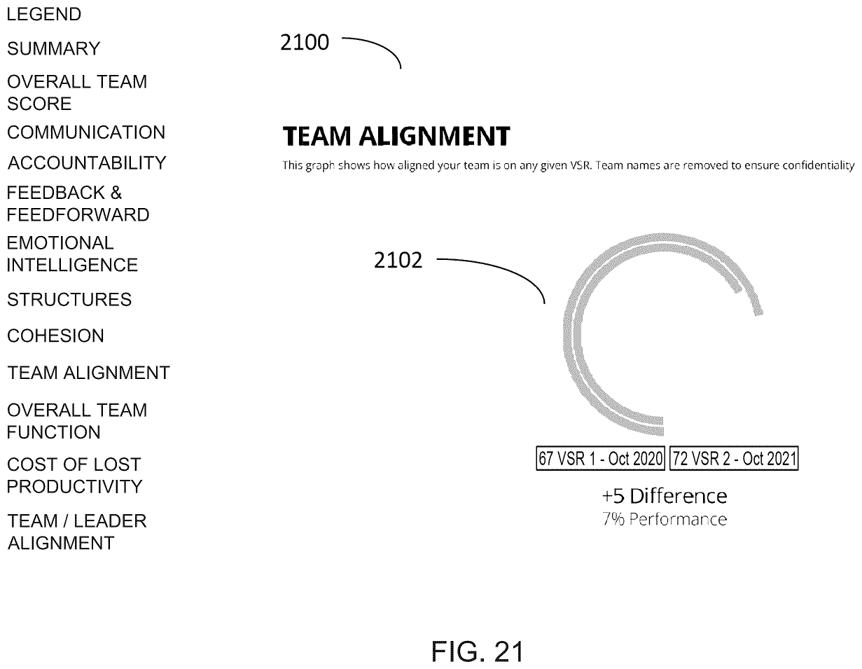

FIG. 21 is an illustration of a device showing operational sequence 2100 that may be performed when running a Vital Statistics Report software. Team alignment graph 2102 is shown to have a score of +5.

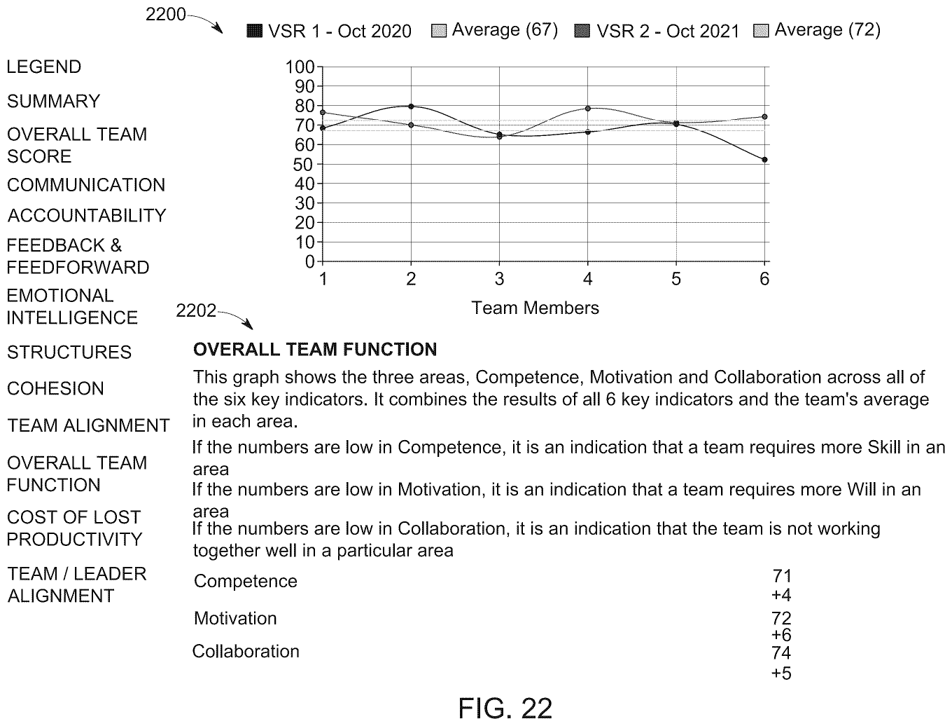

FIG. 22 is an illustration of a device showing operational sequence 2200 that may be performed when running a Vital Statistics Report software. Overall team function data 2202 is shown to have competence values, motivation values, and collaboration values.

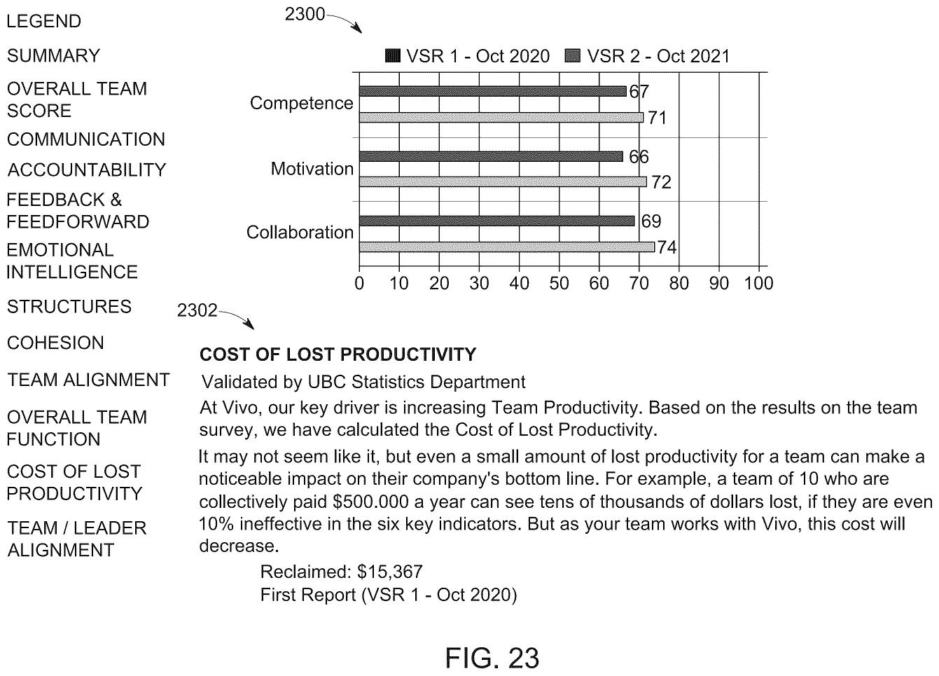

FIG. 23 is an illustration of a device showing operational sequence 2300 that may be performed when running a Vital Statistics Report software. Cost of lost productivity data 2302 is shown to have Reclaimed value of $15,367.00.

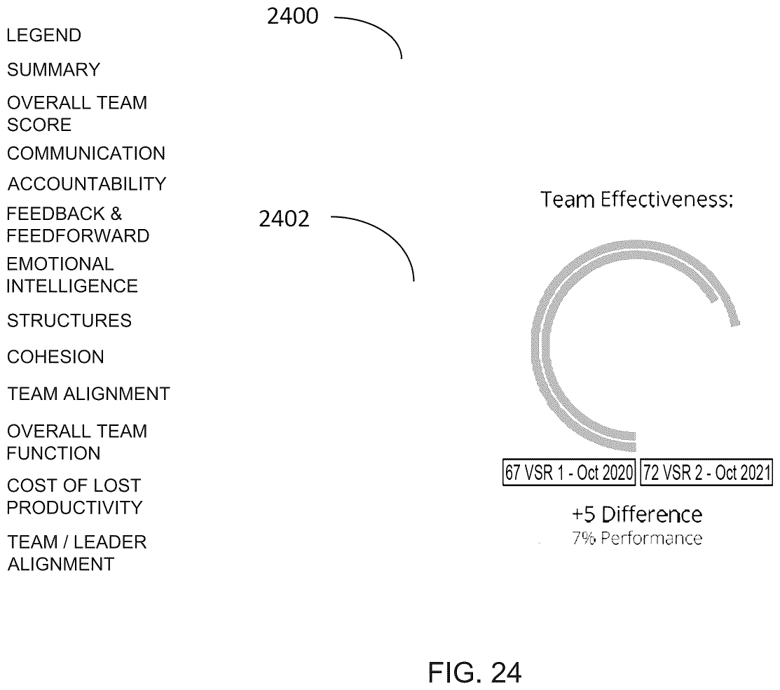

FIG. 24 is an illustration of a device showing operational sequence 2400 that may be performed when running a Vital Statistics Report software. Team effectiveness graph 2402 is shown to have a score of +5.

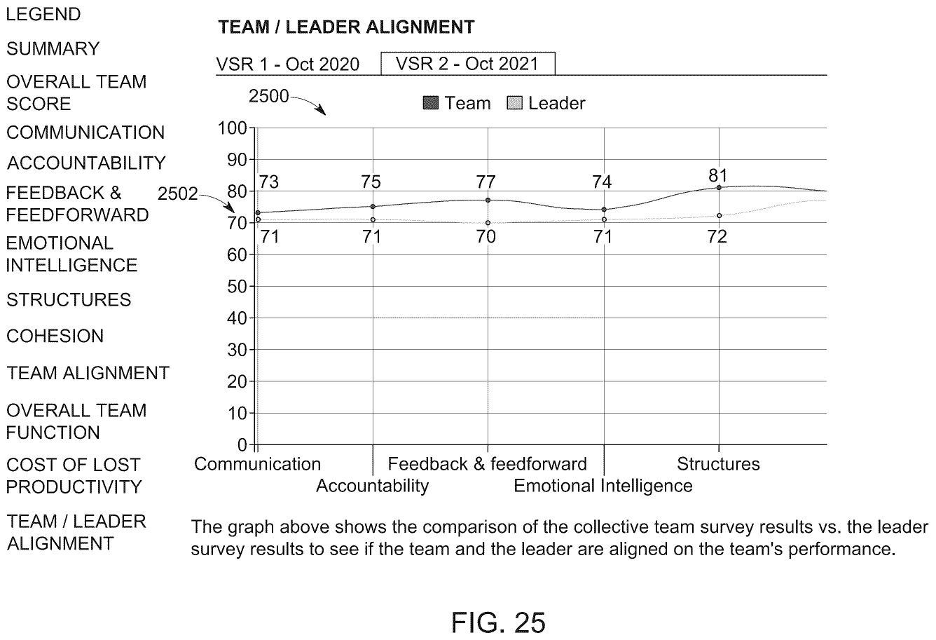

FIG. 25 is an illustration of a device showing operational sequence 2500 that may be performed when running a Vital Statistics Report software. Graph 2502 shows the comparison of the collective team survey results vs. the leader survey results.

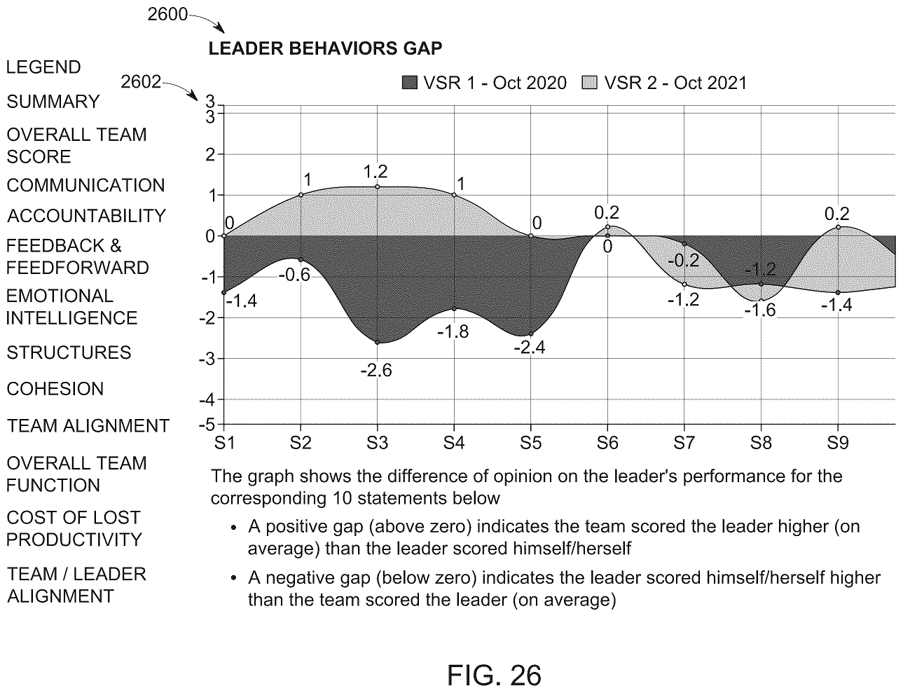

FIG. 26 is an illustration of a device showing operational sequence 2600 that may be performed when running a Vital Statistics Report software. Graph 2602 shows the difference of opinion on the leader's performance for the corresponding 10 statements.

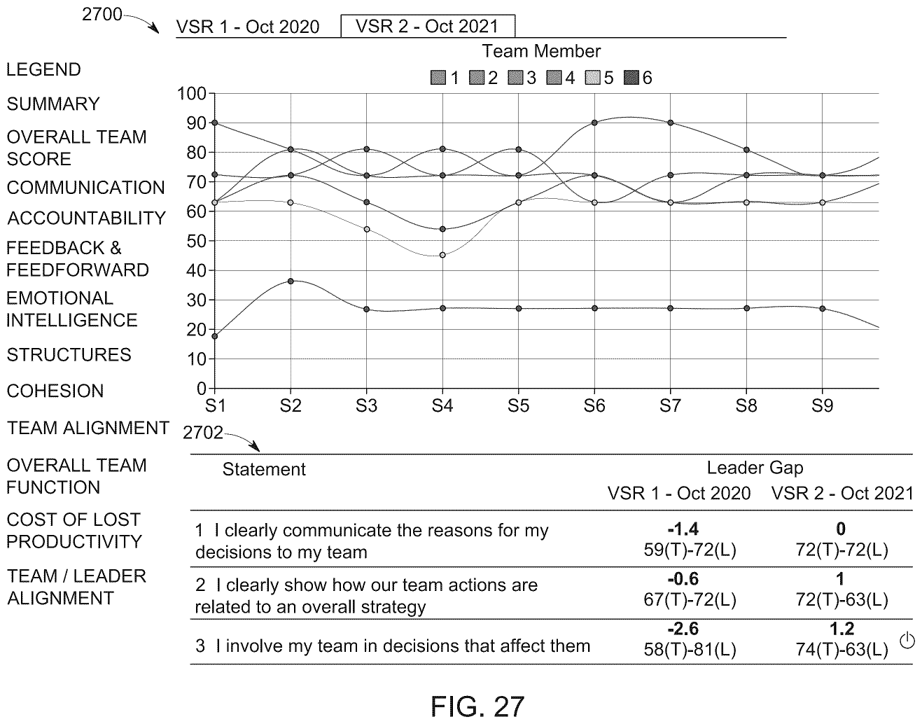

FIG. 27 is an illustration of a device showing operational sequence 2700 that may be performed when running a Vital Statistics Report software. Statements 2702 1-3 are shown.

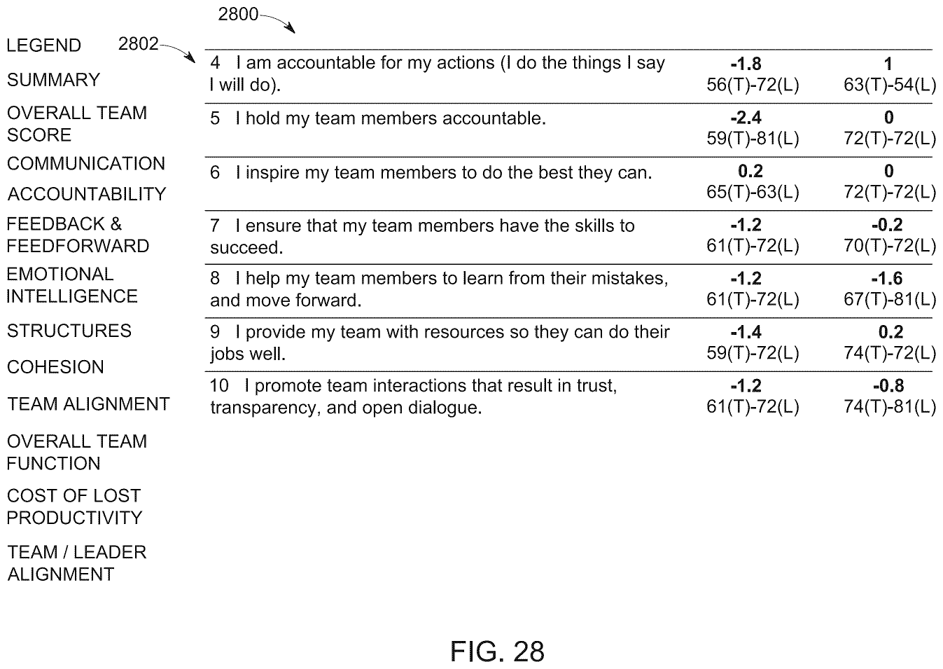

FIG. 28 is an illustration of a device showing operational sequence 2800 that may be performed when running a Vital Statistics Report software. Statements 2802 4-10 are shown.

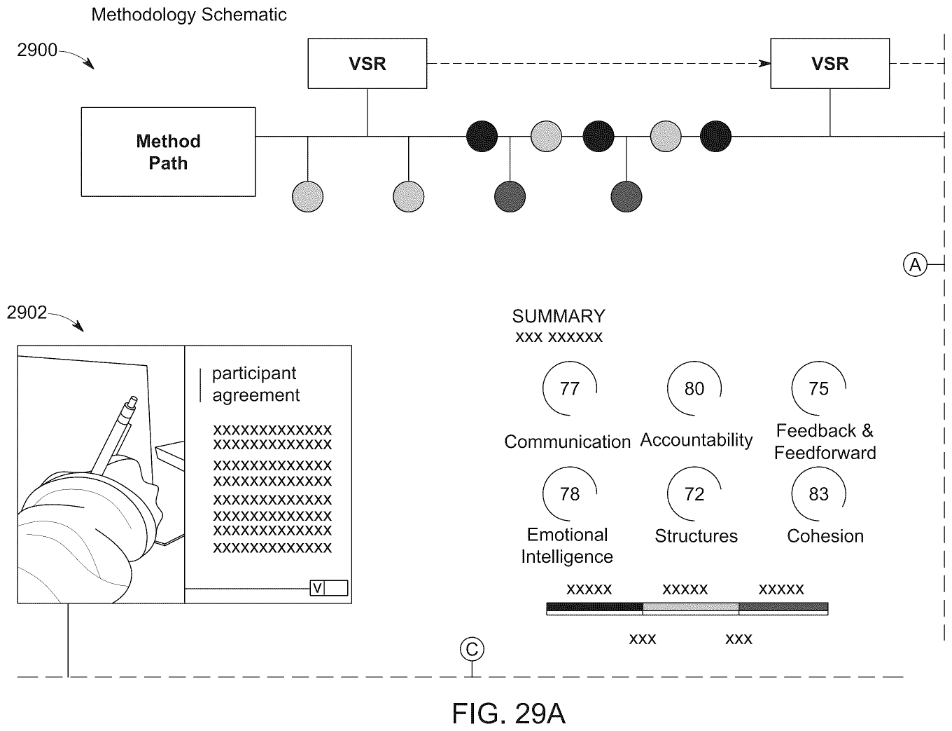

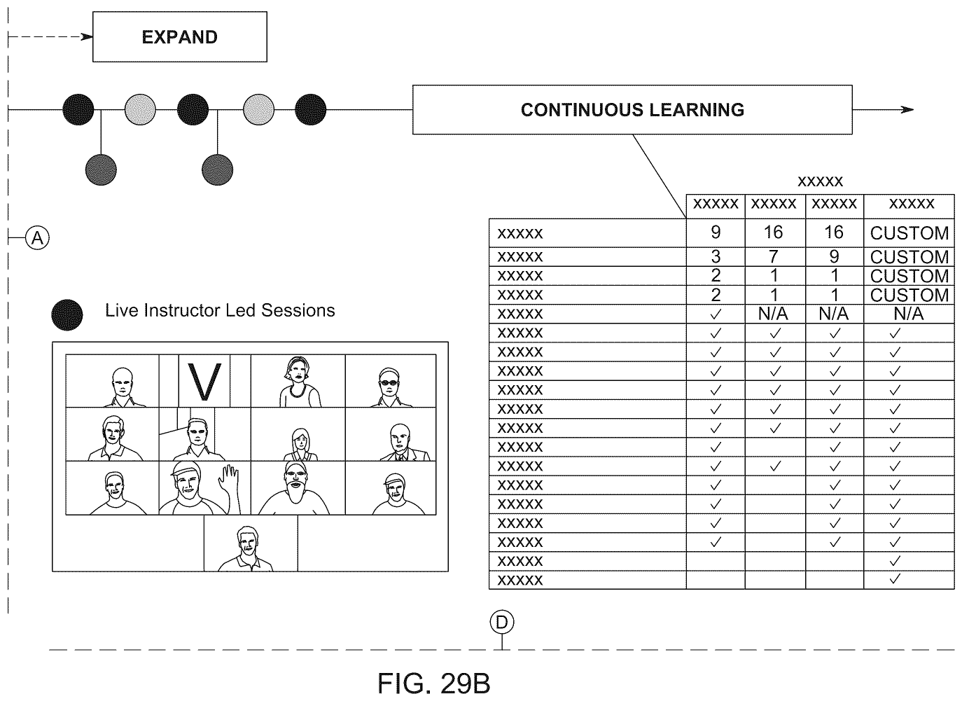

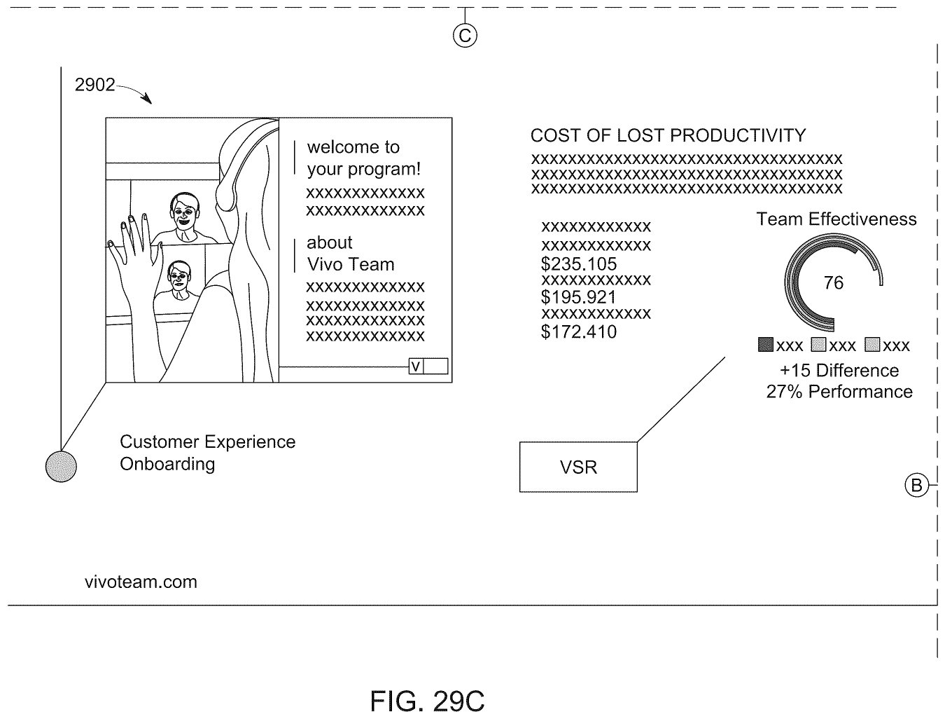

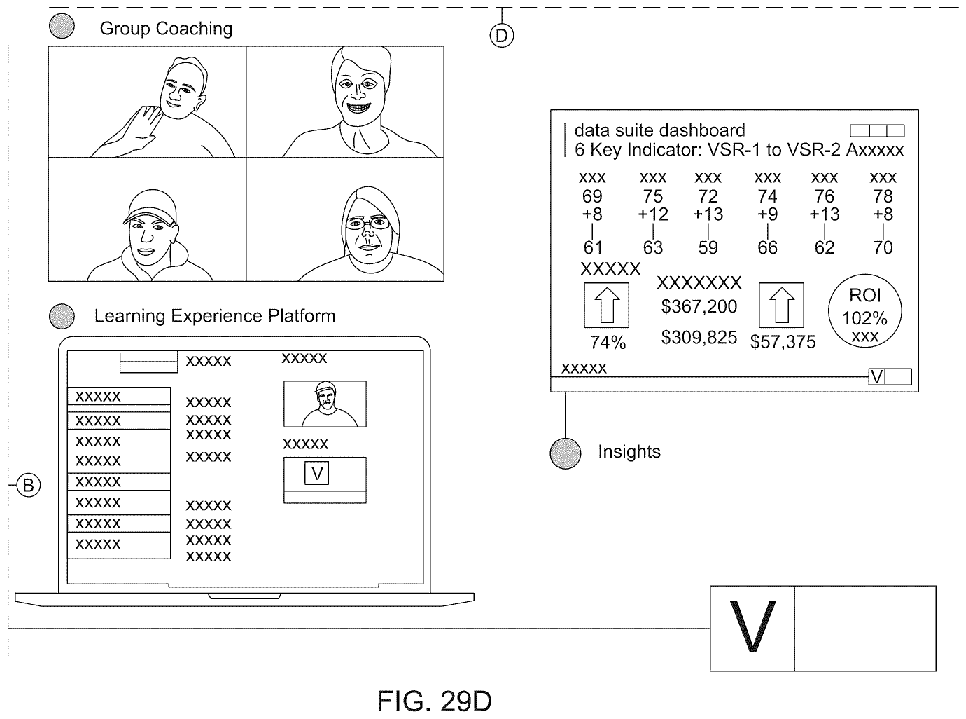

FIGS. 29A-29D show a flow chart 2900 and schematics 2902 of the team development and coaching method depicting the user interface with manager and client video interactions.

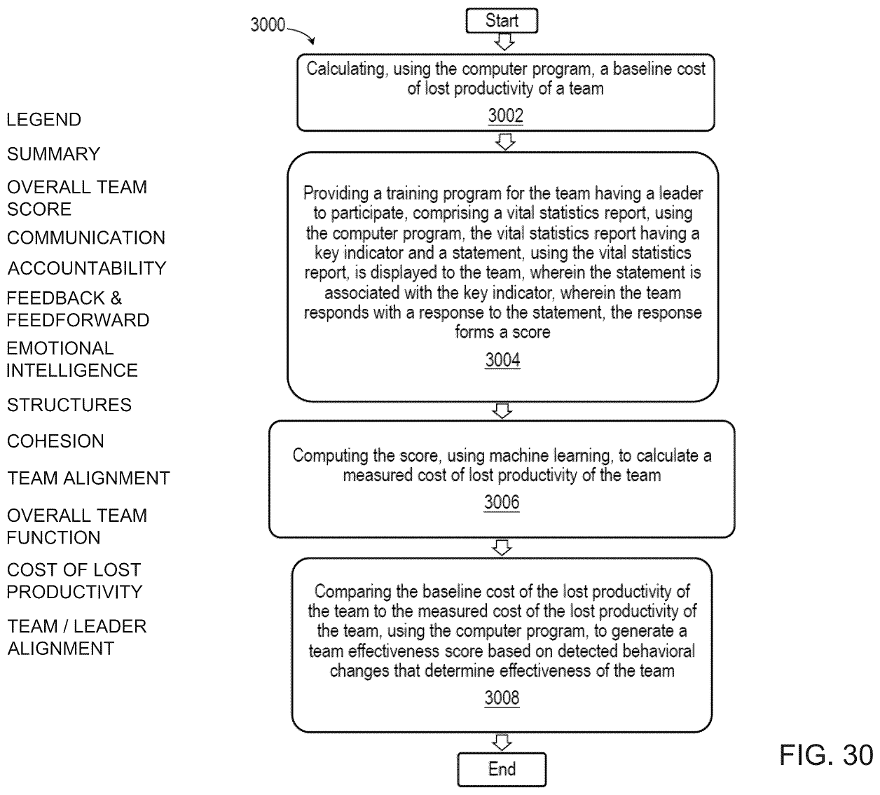

FIG. 30 is a flow chart illustrating method 3000 for a computer program comprising instructions which, when the program is executed by a computer, cause the computer to carry out the following steps. At 3002, calculating, using the computer program, a baseline cost of lost productivity of a team. At 3004, providing a training program for the team having a leader to participate having a vital statistics report, using the computer program, the vital statistics report having a key indicator and a statement, using the vital statistics report, is displayed to the team, wherein the statement is associated with the key indicator, wherein the team responds with a response to the statement, the response forms a score. At 3006, computing the score, using machine learning, to calculate a measured cost of lost productivity of the team. At 3008, comparing the baseline cost of the lost productivity of the team to the measured cost of the lost productivity of the team, using the computer program, to generate a team effectiveness score based on detected behavioral changes that determine effectiveness of the team.

The instant invention fills the need for a clear and data-based measure of how well a team and its leader is performing. The instant invention calculates a baseline cost of lost productivity (sunk costs) of a team in dollars so that when a team and leader go participate in a team development program or a leader development program over time it measures behavioral changes that either help or hinder team and leader effectiveness. It also is used to help organizations keep track of how well hybrid and virtual teams and leaders are performing over time. Additionally, the instant invention calculates the cost of lost productivity (sunk costs) of a team in dollars and conversely, when teams and leaders go through a training program it measures particular behavioral changes that either help or hinder team and leader effectiveness.

Many articles and presentations have been written to address the various issues but none have provided a comprehensive solution. Typical attempts at solving the problem include: People-Centric Analytics; How Can Employees Benefit from Data Analysis?; Strategic Workforce Analytics Report; Learning Analytics Annotated Bibliography; Measuring Engagement; Measuring Employee Engagement; Low Completion Rates; Retention in Online Courses: Exploring Issues and Solutions; Mercer Global Report HR trends; 2020 Global Talent Trends Report; The Future of Work; 2019 Mercer Global Talent Trends Study; 2018 Mercer Global Talent Trends Study; AI and Leadership HBR; As AI Makes More Decisions, the Nature of Leadership Will Change; Director of People Analytics; Steal this People Analytics Leader Job Description!; CX Data Quadrant; Understanding Customer Survey Data: Descriptive, Predictive and Prescriptive Analytics to Improve Customer Loyalty; Analytics; Gut; and Intuition to name a few.

The instant invention identifies and analyzes the hidden sunk costs of teams and leaders. That is, the ways a company is wasting their money and disengaging their people.

The problem solved is applying an (anonymous) interactive behavioral analytic process that allows teams to measure how the interactions between team members' interactive behaviors (anonymously) in six key indicators—communication, accountability, interactive feedback, emotional intelligence, structures, cohesion - determine the effectiveness of the team which is measured by a team effectiveness score and a measure of the cost of lost productivity in dollars.

In addition, this solves the problem of measuring how a team's interactive behaviors (anonymously) change (improve and/or decline) over a set time. When someone can measure that change, they can make an evaluation (ROI) of how effective a team development program or leadership development program is. That time set is the length of a team development program and a leadership development program that the team and leader engage in.

The other problem it solves is in team members and leaders are able to identify how individual team members affect the functioning (hinder or help) of the team as a whole. By identifying the helping or hindering team members' interactive behaviors (anonymously) it makes it easier for the team leader to understand the dynamics of the team interactions and then show them how to improve.

The other problem solved is calculating the effects of the differences in perception of a team leader's behaviors and their team member's perception of their team leader's behaviors (anonymously) which has either a help or hindrance effect on the leader's effectiveness. The template for achieving the above is Vivo Team's Vital Statistics Report. It has six key indicators—communication, accountability, interactive feedback, emotional intelligence, structures, cohesion—there are 9 statements per key indicator. Statements are said, not questions because they are asked to what degree they agree or disagree with the statement, not questions (i.e. in communication—“People on my team speak up when they have a disagreement about a decision”).

These statements are perceived, observable behaviors that indicate how each team member perceives the behaviors of their team. There is no interpretation of what those behaviors mean.

Team members and their leader respond to the statements on a scale of each statement on a scale of 1 to 10, 1 “never” and 10 “always”. There are 9 statements for each of the six key indicators for a total of 54 statements.

In each key indicator—communication, accountability, interactive feedback, emotional intelligence, structures, cohesion—3 statements are about how competent the team members perceive their team to be (including themselves); 3 statements about how motivated team members are in a key indicator; and 3 statements about the perception about how well their team members are collaborating in each key indicator.

Using Vivo Team's algorithm, a score of the measure of effectiveness is calculated for each of the key indicators—communication, accountability, interactive feedback, emotional intelligence, structures, and cohesion.

It identifies and analyzes the hidden sunk costs of teams and leaders. That is, the ways a company is wasting their money and disengaging their people.

The decision to ignore and not measure such costs leads to the “sunk cost fallacy.” These costs are not recorded anywhere in the budget. They seem to not exist. But they very much do.

The Delivery Steps:

Diagnose:

Look at how well a team and its leader are functioning to pinpoint areas in need of development before the training begins and use it as a baseline to measure the behavioral effects of the training as well as the ROI in dollars:

Vital Statistics Report (VSR): is deployed before the beginning of the Live-Virtual Instructor Led Training sessions and at the end of the first phase of the Leader or Team Development Program. The initial assessment provides critical performance information and a data set to help drive decisions about your leader's team and leadership development needs, pinpointing key behaviors for improvement. The online assessment is completed by leaders and their team members. The resulting data is used to analyze competence, motivation, and collaboration in the context of the 6 key indicators of high performance, overall team effectiveness, and the cost of lost productivity, while also illustrating team alignment and leader behavior gaps. Additional VSR assessments are deployed throughout the program, ensuring you measure the return on your training investment and understand the progress of your leaders and their teams.

Sample VSR: https://admin.vivoteam.com/report/ba1860715b1e41349b548f1c361556f7.

Train:

Live, Virtual Instructor-Led Training Sessions: Vivo Team provides live, instructor-led online training sessions for participants which are dynamic, effective, and engaging.

Sessions are one hour, held at regular intervals, and participants make commitments to change behaviors. Sessions also include practice, to reinforce key ideas and learnings to help them consolidate the skills each week and apply on the job. This “spaced-learning” model is proven to increase retention rates and learners' success—it makes the learning “sticky”. All content sessions are recorded in case leaders are unable to attend or if they want to review the session at a later date.

Benefits: Interactive elements to boost engagement: Breakout rooms to increase interaction and shared learning; Polls; In-session videos; Reactions; Use of the chat function; Anywhere, anytime learning with a human element—geographically agnostic; Enhances recall value and on-the-job application with spaced learning—learn, practice apply, receive feedback; Facilitates blended learning; Tests participants' understanding of the content using polls and interactive scenarios in real-time; Sessions are recorded and available to review at a later date; Saves time—no travel out of office; Delivered in the flow of the workday in bite-sized pieces; Saves money—renting space, providing food, travel expenses; More employee-friendly, particularly for dual-career couples and single parents' child care, as they do not have to go away for training; Buyers can review recorded sessions to pick up any ongoing issues; Vivo Team can evaluate the performance of their trainers and coaches to increase competencies; and If a dispute arises between what a participant thought was said and what was said in a session—can do a perception check.

Launch Kit: This provides participants the details and information about the program, including schedule, trainer details, Zoom room, technology test, and other logistical details. It also includes the Participant Agreement.

Benefits:

The Launch Kit is that it provides learners with a seamless onboarding experience, taking the weight off of the buyer.

It is professional, clean, and digestible to understand.

Participant & Buyer Agreement: An agreement is signed by team members and buyers. The agreement makes the expectations of the program very clear to all participants and the buyer, through the development of a participant agreement and a buyer agreement. Every business leader understands the critical importance of having a clear contract or agreement. It reduces the probability of future conflicts and confusion. The participant agreement and buyer agreement are clear, written and agreed-upon statements about what is expected and what is offered that is valuable to the parties.

Benefits:

By having learners sign the Participant Agreement before the program begins, this allows for Vivo Team to hold learners accountable throughout the program, as they agreed to participate in the way that the system has outlined for them. This is critical for buyers, who can also use the Participant Agreement to hold their employees accountable.

Onboarding Package with Buyers: The onboarding package is presented in the very first meeting between the Manager of Client Experience and Product Delivery and the main contact of the program (the buyer). This is the first meeting to establish a relationship between both parties after the contract is signed and the sale is closed. The goal of the meeting is to have the Manager of Client Experience and Product Delivery walk through all elements of the program, and outline the next steps and what is needed from the buyer in the onboarding phase of the program.

The onboarding package includes information on program details (including start date, day/time), participants+team breakdown, coaching sessions, the LXP, hardware requirements, participant agreements, participant launch kits, VSR deployment, buyer connections, training outcomes, buyer agreement, and custom program elements.

Benefits:

The value of the onboarding package has two parts—the meeting gives buyers all of the information about the program and they can understand the information that they need to gather on their end in order to successfully kick off the program. The meeting has a very showing and focusing style to it in order for the buyer to feel competent and motivated to get the information back to the Manager of Client Experience and Product Delivery. The second value add is that the deck that is presented turns into a workbook for the buyer, meaning all of the information can be electronically added into the document, saved, and sent back to the Manager of Client Experience and Product Delivery. In addition, they have one other template to complete with the Team Breakdown information, which is also provided to them. Overall, the value is that the system will seamlessly onboard the buyer into the program first, and then onboard the rest of the learners.

Group Coaching Sessions: Two leaders work together in 1-to-2 or 1-to-4 group coaching sessions, which increases motivation and learnings:

Deliberate practice—they practice skills and receive feedback.

Peer-to-peer learning—they watch a peer improve their techniques and skills.

Self-reflection—the opportunity to reflect on their own behaviors allows leaders to catch nuances that might not be captured through 1-to-1 coaching. Leadership coaching with a Vivo Team executive coach in a 60-minute online session to transfer learning, share experiences, and make connections. Each of the 2 leaders completed a template which measured how well they understood the concepts and as a reminder “nudge” about the content).

Why Coaching is Important

To begin, groups of two or four leaders or team members explore real work issues, ideate, and share solutions, then make follow-through commitments to each other. Follow-through is high because they'll be reporting progress to their colleagues in the next coaching session, and their commitment to the program is increased through this process.

Being experts in both science and performance: participants get specific, direct feedback on actual workplace issues. Collaboration grows through experiential (vs. theoretical) learning.

Apply tactics and strategies immediately to ensure the training sticks.

During these 1-to-2 or 1-to-4 sessions each learner receives a personalized coaching event while the other learner(s) observe. The roles are then switched. This technique deepens and accelerates the learning experience so learnings can be easily applied to work situations (a process referred to as double-loop learning). Teams and leaders that are cross- departmental or in different geographical areas can share ideas and gain key insights into how the organization works.

Benefits:

Training alone increased productivity by 22.4% while training plus coaching increased productivity by 88%. http://www.clevelandconsultinggroup.com/why-coaching.htm.

Vivo Team Experts: A dedicated instructor and a web-tech will facilitate and moderate each online session. These experts are trained to Shine Online!, meaning they consistently hold leaders accountable to using the new skill sets being taught in order to achieve the desired results that have been identified as priorities.

From there, they begin their Shadow Period of Onboarding. Our EVP of Talent Activation and People Analytics, Dr. Jim Sellner, works directly with the coaches to teach them the Vivo Team methodologies, content, and VILT processes. This happens through recordings, by attending mock training sessions, and by attending live training sessions. In total, this Shadow Period is 20 hours of direct training, plus 20 hours of the coach preparing and reviewing Vivo Team's content library.

Benefits:

Vivo Team coach and trainers deliver consistent, impactful programs.

Learning Experience Platform: Programs include access to on-demand resources in Vivo Team's proprietary learning experience platform (LXP). Throughout training, participants have anytime-access to the platform which contains micro-learnings, all learning models, curated and custom video content, recorded sessions, and upcoming schedule. Coach Connect requests to our LXP make the learning specific and customized to your workplace situations.

Sample Coach Connect video: https://drive.google.com/file/d/11X7iLb6SxRq6tqR6HK3JtgqjBO5fLiyL/view?usp=sha ring.

Transcript: Transcript:

What to do when someone is not listening to my very detailed instructions? That is fantastic news! Look at that is a gift because what that means is they are telling you that they didn't get it. Now it may be a bummer for you because you've gone through details, but better that than then pretending to get what you said. Now here's the next thing to do. You say okay I heard you say why you weren't listening to my very detailed instructions. There's “that's right” and what I′d like you to do is write down what I say because I think that will help you (the person) remember and you can detail with much more and you (the sender) is giving me instructions can also check to see how accurately the person brings the stuff down because when you are finished, you ask the person now please tell me what you understand from your notes. Very clear, excellent, thank a person for facing up to not listening!

Benefits: The value of the LXP is that there's a lot of moving parts when it comes to a leadership training program, and learners already have enough details to keep track of in their day. This is where the LXP comes in. It is the home base throughout the duration of the program. The value of the Coach Connect is that Vivo Team is there to support the learners both inside and outside of training. They always have access to an expert coach to help them navigate situations.

Hot Sheets: Participants receive a supplementary one-pager outlining key concepts for each session in a bite-sized format. Measuring how many participants open and read the hot sheet is a measure of engagement.

Benefits: The value is it increases the ability to remember and apply on the job; Executive Review: Our EVP of People Analytics and Talent Activation reviews instructor-led and group coaching recordings to ensure training is aligned with client objectives and is relevant to participants; Team & Manager Transfer: To encourage the application of the learning for the leaders, summary videos (3-5 minutes of what was covered in the session) and Hot Sheets are shared with all of the leader's direct reports and their manager; Sample Team Transfer Video: https://www.youtube.com/watch?v=FKXIXeqwEsI.

Transcript:

Effective project results will require some conflicts. It is desirable to have some conflicts during conversations for the pure virtue that conflicts generally mean there is differing viewpoints and/or differing opinions. With differing viewpoints and/or opinions comes the facilitation of innovations. Instead of avoiding conflict choose to learn how to navigate conflict in effective conversations. For example, “I'm John Doe and I'd like to go through a hot sheet here on navigating conflict. All of you are familiar with the communication loop. It's now from time to be familiar with what happens for you. What's the awareness of your own behavior? What is your primary conflict style when a conflict appears? Do you accommodate? Do you avoid? Do you compromise? Do you collaborate? or Do you compete? This hot sheet has a lot of information in it and I'm going to let you review all of the conflict styles when they're useful and when they're not useful.”

What's most important is that during analysis of the graph on the right hand side where the concern for other and/or cooperation is low to high as displayed on a bar on the left and on the horizontal axis. From low to high, the concern for self is assertiveness. The most important and effective style with others is a collaborating style. For example, every conversation may be different, the temperature can be higher or lower, and it could be more difficult to be dependent on the competence of motivation and awareness of behaviors. To be in a collaborating style in a conflict is high concern for others and high concern for an individual.

Sample hot sheet: https://drive.google.com/file/d/1Y0ABxwHJR9ZPLuX2Jx09oAA7qPAg8-H/view

Manager Connect: Leaders will do regular check-ins with their managers throughout the program to increase the transfer of learning across all levels of leadership. Guidance is provided for both the managers and the leaders on the structure.

Spaced Learning with Interleaving.

Spaced learning is a series of short, intense training sessions punctuated by intervals of no learning, which allows participants to implement the training tools right away. Content is learned faster and retention rates are higher plus the shorter sessions fit seamlessly into the flow of the workday.

Certificates of Completion: All participants will receive a Certificate of Completion upon completion of the program. The Certificate recognizes the development of professional and team collaboration skills to help build stronger teams and leaders. This certificate can be used for industry training and developing credits. For example, a CPA needs a certain number of professional development hours to retain their certification. The Vivo Team system can also provide a letter confirming the number of hours completed in the program, if necessary, for self-reporting. All participants are invited to add their Certificate of Completion to their social media profiles.

Track

Insights: Vivo Team and the client will collaborate throughout the process to ensure expectations are being met through different methods.

Insights Updates post session summary emails.

Insights Huddle midpoint feedback session and review of progress.

Insights Analysis review a suite of data; the participant's progress, challenges, feedback, attendance, hot sheet and recording review statistics, and measurable results of the training.

Benefits: The value of the Insight Updates is that the buyer is receiving key updates on the program, throughout the program, on a weekly basis. It's a critical point of contact to keep them in the know, and also where the Manager of Client Experience and Product Delivery can raise any yellow or red flags. This also gives the opportunity for the buyer to respond, ask questions, and get curious.

Transfer of Learning Commitments: At the end of each content session, participants are asked to write in the chat what and how they are committing to doing, as a transfer of their learnings, into their day-to-day work. In the next content session, each of those commitments is reviewed to get a check-in of how people are transferring their learning and to make suggestions for improvements. The assumption is that the amount and quality of the participants' input supported with consistent feedback, is a measure of what they are learning and how they are applying their learnings on the job.

Session Feedback: During the 60-minute content sessions, there is an ongoing gathering of feedback from the participants. This provides an informal loose measure of engagement.

Learning Checks|One Thing : Behavioral learning progress checks allow learners to apply what they have learned and reflected on their progress while improving knowledge retention.

Will Thalheimer Poll (in lieu of Net Promoter Score): At the end of our leader program, the participants are asked to give direct feedback on the effectiveness of their experience and their recommendation level. The questions asked are:

If someone asked about the effectiveness of this leadership program, a response output is, “Choose One: The program is too ineffective to recommend it; The program is ineffective enough that I am hesitant to recommend it; The program is not fully effective, but I would recommend it if improvements were made; The program is not fully effective, but I would still recommend it even if no changes were made; The program is effective, so I would recommend it; The program is very effective, so I would highly recommend it.’

This question in the survey is based on Will Thalheimer's modification of the Net Promoter Score. The goal is to have 80%-100% of participants choosing to recommend the program—this scoring system is custom to programming in the L&D space. Our current recommendation percentage from 2021+2022 is 97%.

Vital Statistics Report (VSR) Comparative: Near the end of the program a second VSR is deployed to teams to measure the progress—or lack thereof of behavioral changes in the six key areas of team effectiveness—Communication, Emotional Intelligence, Accountability, Structures, Cohesion, and Interactive Feedback—and continue to develop the next steps. These VSR results are presented along with other insights to our buyers, team members, and leaders.

Benefits:

The value of having the second VSR review is that participants get to see the growth, decline, or equilibrium of the results compared to where they first started. The participants can see the effects of implementing the training in their every day, which will impact the results of the survey. The participants can also share their reactions/thoughts to the results.

Operations

Internal Vivo Team elements in the administration and delivery of the program.

Tracking Document. Each client has an in-depth tracking document with all key information about the program, the participants, and the data on their participation, and progress through the program. The tracking document allows Vivo Team to function efficiently and effectively without misplaced information.

Internal Kick-Off Meeting. Each client is unique, and a unique offering Vivo

Team provides is a personalized plan for each client using all data available. In the internal kick-off meeting, information is shared on and goals/objectives as well as details around the operational aspects of the program. This meeting happens before the sensing interview calls with the client.

Client management tools throughout the program, Vivo Team hosts weekly client meetings and dedicates a slack channel to ongoing key information about the client programs for the full team to follow.

Internal Debrief Meeting. At the end of a program , Vivo Team holds a debrief. The meeting addresses: “What worked well”; “What needs improvement”; and “What's missing from the program”. This allows for the opportunity to identify improvements in the delivery of future programs through shared insights.

The administrative people and the Vivo Team's trainers'/coaches' performance are evaluated based on all the data gathered from the participants and client's executive team during the program. For example, after every second Live, VILT content session the participants give feedback on whether they judged that session to be useful and well- delivered.

Future Features

Continuous learning and development planning: learning highlights testimonials, related VSRs, ROI; executive themes and review; Purposed development path to get teams to blue across 6 key indicators; Investment against projected ROI or aggregate VSR results includes value quote from Dean Dobrinsky and Anna Maria about the value of this vs. urgency planning; HR buyer coaching sessions.

A recent survey indicated that 96% of top talent leaders feel coaching helped them be more confident in their ability to succeed in their role (AceUp).

A HR Buyer is provided with coaching to support them through our training programs. The coaching is designed to learn more about the organizations that are working with the system. It is not a sales call; it is a coaching conversation adding value to our buyers as they navigate their role. The coach then documents particular pains, challenges that are happening. The system can offer ideas of how it can support with resources and solutions in alignment to the hurdles to decrease cost and time-intensive processes.

The sales, delivery team, and customer experience manager need to be informed, respecting confidentiality, and utilize the information from the perspective of partnering for a better outcome.

Board insights report.

This report would be customized to be shared with members of a board for a company to show where the company is tracking. The messaging and the focus of this presentation would be customized to be suitable for delivery to a board of directors.

Team Transfer Tracking

Reporting on the engagement of the team transfer feature and how many people are reviewing the content—hot sheets and videos and how to increase the engagement of those elements.

Onboarding Video

Adding a comprehensive onboarding video to our process to support the buyer and participant onboarding to ensure a clear and effective process. Have a real cost. It is like a leaking underground water pipe. You can't see it but its wasting water nonetheless.

Economists consider payments, investments, or costs which can never be recovered as sunk costs.

When looking for ways to manage costs, managers and executives are trained to ignore money already spent in the past, which is gone and can never be recovered. They focus instead on how money can be spent going forward.

When it comes to tracking the cost and value of meetings (Structures in Vivo Team's VSR), managers will dismiss the cost of people's time as one of these sunk costs because they've already committed to paying salaries.

The decision to spend salary dollars is in the past—done, over, and can't be undone without major disruption to the organization.

And here's where that thinking fails: while you may have decided to spend salary dollars in the past, you're actually spending them RIGHT NOW and every day going forward that you keep that person involved in your team.

Opportunity costs examine the impact of any given choice. The term “opportunity costs” comes from the notion that every choice closes off an alternate choice, so if people waste their time and/or money on an unworthy activity, they can't pursue more profitable opportunities.

Managers measure opportunity cost by putting a dollar value on a person's time—multiplying the time someone spends by either their hourly cost (burdened rate) or their billable rate.

Calculating the cost of your people's time spent in meetings tells you a lot about your organization's focus and productivity, showing what percentage of your operational costs go to talking about work rather than producing work. Once you see this figure, you can ask the next question: how can you be spending that time and money more effectively and efficiently?

If you want to maximize opportunity costs, you need to stop wasting time in bad meetings for example, Increasing employee's “soft skills”, “power skills” (Josh Bersin) or “interactive skills” (Vivo Team) are proven ways to do that.

So the six key indicators in the Vital Statistics Report, identify sunk costs in—communication, accountability, interactive feedback, emotional intelligence, structures, and cohesion from that diagnosis Vivo Team makes recommendations for how to decrease sunk costs while recommending how to increase opportunity costs through task-specific behavioral improvements of team and their leader.

When many Vital Statistics Reports are deployed to many teams and leaders across a company the company can see what its sunk costs are. Vivo Team then outlines a plan of action for task-specific performance improvements.

Vivo Team teaches teams and leaders how to become more successful personally and professionally. The data indicates that the leader's behaviors can make an impact on one or more of the key indicators which in turn has an impact (+_) on the team's effectiveness.

To an HR professional:

It is a data-based people analytics model used in learning and development for diagnosing, analyzing, predicting, prescribing and evaluating leader development programs over a set period of time and team development programs over a set period of time.

It is also a data-based people analytics model for measuring the overall health of multiple teams in an organization either in one time period, or over a set time period.

It also measures the difference between how a leader perceives their behaviors and how that leader's team members perceive that leader's behaviors. It calculates, based on those differences, a leader effectiveness score.

The most effective approaches to developing highly effective, highly productive, highly engaged teams?” The assumptions are drawn from a meta-analysis of existing literature, in-the-field research reports, and our own combined 80 years of experience working with teams and their leaders.

The assumptions consider the evolution of the workplace dynamics, as described by Bersin by Deloitte, illustrated in the diagram below:

The Vivo Team method is a learning methodology. The Vivo Team combines data science, user-friendly design, and descriptive, predictive and prescriptive talent insights to transform an organization's good leaders and teams, into great ones.

Measured in both behavior and dollars, the result is the most rewarding performance improvements possible.

Now for the first time, businesses can track the ROI of their talent activations like never before and stay focused on employee productivity at once. People no longer are a point of pain, but are mindful, active participants in helping to grow the business.

Being mindful is demonstrating awareness, compassion and emotional/behavioral intelligence in all aspects of life.

Improvements.

Productive Teams Start With Behavioral Intelligence.

Where emotional intelligence is internal, behavioral intelligence is external;

it's action people can see. Behavioral intelligence refers to the active choices others notice and respond to that create objective, measurable benefits for both individuals and teams alike.

These are some dynamics of a “Team”?

A company is a team made up of a bunch of smaller teams.

Teams can be in an agile framework or based in many different locations.

A team has well-defined, common goals that serve to achieve the organization's strategy.

In highly functioning teams, leaders ensure that each member understands the goals, and works to develop the required competence and motivation to productively and collaboratively to achieve those goals.

A team is two or more people assigned to jointly succeed at achieving the stated goals.

A team has a shared understanding of the role of each member. Everyone's roles in a successful team are clear to everyone else - not just to the individual with a specific responsibility.

In productive teams, there is an “I”, a “we”, and an “us”.

The “i” is what an individual brings to the team.

The “we” is those individuals collaboratively fulfilling the team's goals.

The “us” is the unified “we” that supports the overall purpose of the organization.

Dr. Lindred Greer, an associate professor of organizational behavior at Stanford's Graduate School of Business stated: “Everything in a company is determined by the quality of team dynamics, and the ability to effectively lead teams is at the heart of managerial success.”

“Referring to our own Asia Pacific study in which the Best Workplaces are compared with “the rest,” the observations that psychological safety (defined by employees' perceptions of a mentally and emotionally healthy workplace, and of leaders recognizing honest mistakes) is significantly more positive in the Best Workplaces . . . accounting for country differences, company size, and industry dynamics, the results indicated that psychological safety had 10 times the impact on teamwork relative to all other organizational climate factors combined.”

Our operating assumptions about Vivo Team's methods:

These assumptions are developed to address what Josh Bersin of Bersin and Deloitte says: “People tend to trust human judgment over algorithms. Even when an algorithm consistently beats human judgment, people prefer to go with their gut.”

Vivo Team's People Analytics is a data-supported, behavioral approach to diagnosing, training and tracking leader and team competence, motivation and collaboration.

These assumptions are generated from a meta-analysis of hundreds of research-based sources and in-the-field reports about what the true descriptive, predictive and prescriptive differentiators of team and leader productivity are.

Michael Dell, CEO of Dell Technologies, was asked by PwC what he considered the most important trait of the leaders of the future. Without hesitation, he said “curiosity”.
1. Vivo Team People Analytics - Describe, Predict, Prescribe.

Vivo Team's people analytics is a data set that describes meaningful patterns of human behavior in teams and leaders, allowing the prediction of probable consequences and prescribe solutions to potentially negative behaviors in advance.

People analytics support and improve decision-making with data, rather than depending on anecdotal or strictly intuitive experience, confirmation biases, fundamental.

Attribution errors and/or denial. Higher-quality decisions are based on data analysis, diagnosis, prediction, and prescription. The approach is no action without research; no research without action.

The goal is to aid decision-making that leads to behavioral-based performance improvements in teams and leaders help them become mindful accelerators of the business.

Vivo Team's People Analytics Assumptions

People analytics are powerful tools to describe, predict and prescribe what a company needs to do to create a productive, profitable work environment. Describe=this is what people are doing and this is the cost of unproductive human behavior in both results and in dollars.

Predict=if you keep doing what you're doing the results are likely to be . . . Prescribe=based on the data, for greatest success, suggested specific ways to support teams and leaders in becoming more competent, motivated and collaborative.

People's “street smarts,” generated from life/career experiences, enhance the value of people analytics.

Successful organizations are made up of many individuals, teams and leaders who are committed to continually developing, learning and activating their talents. People analytics provide the roadmap to achieving the desired successes.

People analytics uncover the functional and dysfunctional behaviors of leaders and their teams.

People analytics expose the differences between what a company says it values and what it really values, as observed in what behaviors get rewarded, punished or ignored. This disconnect is the source of low productivity and engagement.

There's no point in doing people analytics unless decision-makers are committed to providing the resources to do what's required to improve. Be clear what actions “You can lead a horse to water . . . ” Team and leader talent and skills activation is a voluntary, participatory sport. People analytics can create thirst.

Learning is a waste of time and money unless positive, performance-based behaviors are translated into business results.

Learning is pleasurable when it results in more satisfaction in one's career and personal life. Learning is painful when people resist change. People resist when they don't understand or accept WIIFM (What's In It For Me).

There is a growing interest in the personalization of the employee experience. People analytics and digital tools make personalization possible.

Customer satisfaction is directly related to employee competence, collaboration and motivation to serve. EX (Employee Experience)=CX (Customer Experience)=sustainable profitability.
2. Team's productivity. Training and coaching are delivered consistently within the flow of a regular workday and executed with proven, learner-focused, adult-learning design. Data is systematically collected and tracked throughout the program, providing a trajectory of team members' progress during the training period. It has been proven, measurable results in this arena: increases in team productivity, enhanced business outcomes and a healthier bottom line.

UPS is a great example of using data and analytics to increase productivity. UPS has 60,000 drivers worldwide. They gathered data on drivers' driving habits, then trained them to change those habits. The results: UPS eliminated 20 million miles a year, saved 2 million gallons of fuel and stopped 20,000 tons of carbon emissions from poisoning the atmosphere.

As individual development is surveyed and measured through the training process, patterns of learning and performance emerge. This data, in combination with individual statistical facts like demography, learning profile, engagement in the learning process and application of what's been learned, provides a wealth of analytical data that can be used to measure training effectiveness. Team members are identified as either engaged, inquisitive or involved learners, thereby allowing leaders to make more timely interventions to ensure people stay engaged. Interventions might include offering extra social, content or application support, or presenting more challenging tasks.

As UPS says: “The goal is to turn data into information and information into insight, and then to turn insight into action.” Training based on analytics motivates people and increases team productivity.

Our experience is that when it comes to analytics, the sum is greater than its parts. The data and collective learning as a result of team training cascades down into and throughout the organization, benefiting the business as a whole.
3. If There Is Not An Audience, There Is Not A Show.

Productive, cohesive teams are the result of a highly effective, leader-team member relationship. There's no effective team without an effective leader and no effective leader without highly engaged team members.

Zenger-Folkman combined differentiating competencies into a short, predictive competency model by analyzing over one million, 360-degree feedback assessments.

Through behavioral clustering, six prevailing leadership competencies emerged.

When leaders apply Vivo Team's competencies, similar to Zenger's, their behavioral effectiveness rises into the 90th percentile. The data supports Zenger's findings that the leader's behaviors can make an impact on one or more of the key indicators which in turn has an impact (+_) on the team's effectiveness.

46% of leaders/managers who are moved into new roles, fail to meet objectives.

No matter what measure you use, companies with effective leaders execute better and consistently deliver long-term business results. In fact, high-performing organizations that continually invest in their leaders generate “nearly 60% improved business growth, reported a 66% increase in bench strength, and showed a 62% improvement in employee retention.”
4. Team—Together Everyone Achieves More.

As noted, author Jim Collins says, “Great vision without great people is irrelevant.”

At Vivo Team, operation on the premise that competent, motivated people are an organization's most valuable resource is key.

Why?

Because not only are people the prime resource businesses have for sustainable success, but nearly every asset a business has is the result of successful interaction between two or more individuals. And two or more individuals working together is . . . a team! It is within the scope of this invention for a service, a physical product, and/or a customer base to have continued growth being dependent on how well teams of competent, motivated people work together. Effective teams mean there's more experience, creativity, ideas and solutions to draw upon, resulting in more of everything.

If one person is good, a group of capable, inspired, collaborating people working together is great!

With people analytics the performance- based behaviors can be described, predicted, and prescribed that advance and/or impede a team's performance.
5. Dealing with People is a Tough Gig.

Activating, maintaining and nurturing talent is challenging because humans are complicated!

The main reason for tension between people is a result of fundamental attribution errors and confirmation biases that distort judgment about why people do what they do. The result is interpersonal conflict, resistance, and dis-engagement.

At any given time, individuals can be some combination of brilliant, unpredictable, inspiring, emotional, creative, all manner of dysfunctional and sometimes just plain weird.

Add to this the concept of “bounded rationality,” whereby two individuals react differently when faced with the same conditions, and employee function becomes confounding: people in similar circumstances can be either high performing or low/under-performing, with little sense of what makes the difference.

Developing an effective talent and skills activation, retention and management strategy is complex, but essential to an organization's bottom line: research by McKinsey and Company reveals that companies excelling in talent hiring, development and management typically deliver returns to shareholders that are more than one-fifth, or 22% better, than those offered by their industry peers. Data proves the point: Investing in employees pays measurable dividends. When people are well trained, motivated, and given a great work environment, they'll work with passion to feel good about themselves while advancing the company's mission. This is referred to as enlightened self-interest.
6. The Hard Truth about Soft Skills.

The success with which individuals understand and exercise soft skills will either build or erode team productivity.

To wit: Stanford Research Institute International, the Carnegie Mellon

Foundation and the American Management Association all found that 75% of long-term job success depends on “people skills,” while only 25% depends on technical knowledge.

Google, in its Project Aristotle, spent two years discovering why some teams were productive while others were not. Ultimately, they determined “who is on the team matters less than how the team members interact, structure their work, and view their contributions.” It was the soft-skills that got them across the finish line on time, on budget.

Fact: Organizations that encourage and facilitate the development of employees' soft skills experience a marked competitive advantage in the marketplace.

Why are soft skills so crucial?

Because, while an employee's technical (hard) skills will get a business going unless people also know how to collaborate, how to increase others' competencies and how to effectively work in a team framework, an organization's continued growth and success is at risk. Do the people in your business systematically behave in ways that bring out the best in themselves and others? If not, the key is to develop their soft skill set.

Vivo Team's people analytics Vital Statistics Report measures individual capacity in six, key, soft skills: Communication, Feedback, and Feedforward, Emotional Intelligence, Cohesion, Structures and Accountability. Plus ,The Leader Behaviors Gaps. The system is configured to Diagnose, Train and Track team members' soft skills in order to increase overall team effectiveness.

The basic principles of the Diagnose, Train and Track method are:

Learning as a process, not an event.

Motivate a desire to change by providing challenges as well as support, over time.

Align and Sustain the soft skill set, rather than simply giving employees the tools they need and letting them go.

Modern technology lets us see the correlation between performance-based behaviors and business performance more accurately, more quickly and more easily than in the past. Companies used to go around conducting ‘critical incident interviews,’ trying to identify the unique behaviors of employees that led to success (or failure) in specific situations. Today, the significant advantage of People Analytics allows better, more reliable and relatively unbiased understanding in comparatively short order.

Vivo Team has done the work of finding the true differentiators that make highly productive teams and leaders. The results of the analysis can be used to improve both recruiting and development. It's also critical that the benefits for employees are clear: Often the focus of HR analytics initiatives is on the organization, and less on employees themselves. Our view is that EX (Employee Experience) directly affects CX (Customer Experience).

Answering the question: “How will companies and employees benefit from this effort?” is a useful starting point.

Vivo Team's algorithm calculates/combines the scores of all six key indicators, and in combination with Vivo Team's research into how each of the six key indicators affects the effectiveness/productivity of a team, a measure of the cost of lost productivity in dollars is calculated by the algorithm.

Algorithm Calculations below each section.

CALCULATION: Six Key Indicator (Communication, Accountability, Feedback, Emotional Intelligence, Structures, Cohesion) Questions.

In each section there are 3 questions each for Competence (C)+Motivation (M)+Collaboration (Coll). A. Total Scores of C+M+Coll. B. # of statements x maximum of possible scores x # of respondents. Factor. Divide A by B. Distortion Is 1−0.1=0.9 and create percentage. CALCULATION: Six Key Indicator (Communication, Accountability, Feedback, Emotional Intelligence, Structures, Cohesion) Questions.

In each section there are 3 questions each for Competence (C)+Motivation (M)+Collaboration (Coll). A. Total Scores of C+M+Coll. B. # of statements x maximum of possible scores x # of respondents. Factor. Divide A by B. Distortion Is 1−0.1=0.9 and create percentage.

CALCULATION: Team Alignment. The average % of all the six key indicator results. Grading Scale (taking into consideration the 10% distortion factor).

CALCULATION: Team Function. The average % of all the competence, motivation and collaboration results.

CALCULATION: Cost of Lost Productivity. Take the sum of the 6 Key Indicators (6KI) percentages, divide by the # of 6KI to get the average score of all 6KI's then multiply by (1 minus average 6KI score) equals the “factor”.

Therefore, the Cost of Lost Productivity is the # of team members x average salary x the factor.

CALCULATION: Team Leader|Alignment

The average % of all the six key indicator results, removes Leader and presents separately. Grading Scale (taking into consideration the 10% distortion factor).

CALCULATION: Leader Behaviors Gap—Visualization

The system will be exclusively using the team's responses to the questions to construct these scores, given that a leader can skew the results in one direction or the other based on their responses (they are over-or under-confident in their behaviors). This is especially a concern with smaller teams (specifically the potential influence of a leader's responses on the overall scores).

Given the outlier weighting, such that low scores are penalizing the aggregate score further through greater weighting, this weighting will be applied after averaging the team's scores for each individual question (i.e. when averaging across questions). See below for further clarification on the method.

Leader—Competence Score:

This aggregate score will be formed based on responses to the first 5 questions from the team (excluding the leader's responses). To compute this score, the team members' responses (at a given timepoint) will be aggregated following this algorithm:

For each question, take a standard average of all team members' scores to create a single score for each of the 5 questions, resulting in 5 scores (these will be denoted as LDi where i={1, 2, 3, 4, 5} and i represents the question number).

For example, if there are 3 team members in the team (excluding the leader), and each of their scores are 67, 70 and 82 for question 1, then the LD1 term can be computed as:

(67+70+82)/3= [symbol] LD [symbol] _1=73

This is repeated for each of the other questions 2-5 to obtain LD2, LD3, etc. Although a non-integer LDi may be obtained, it is best to avoid rounding them.

With the LDi set (where i={1, 2, 3, 4, 5}), the system will now want to aggregate these together to form our “Competence Score”. The aggregation will initially be of the form:

w_1* [symbol] LD [symbol] _1+w_2* [symbol] LD [symbol] _2+w_3* [symbol] LD [symbol] _3+w_4* [symbol] LD [symbol] _4+w_5* [symbol] LD [symbol] _5=Competence Score with standard average, then wi=(⅕) to ensure that the sum of all wi is 1. However, there are two additional elements that may be incorporated into the aggregation: (1) outlier penalization (increased weighting for low LDi) and (2) doubling the weight to Question 5 “Holds the team members accountable, in a fair way”. To simplify specifying the weights while incorporating these two elements, conduct the following on the weights.

For i={1, 2, 3, 4}, set the wi=1

For i=5, set wi=2

For any 65≤LDi<70, multiply the corresponding wi by 1.5.

For any LDi<65, multiply the corresponding wi by 2

Take the sum of all wi (wsum) and divide each wi by that sum to normalize the weights and ensure that their sum now equals 1.

Once the weights have been readjusted, they may be applied (along with the previously computed LDi) to the above equation to compute the overall Competence Score. This Competence Score can then be rounded to the nearest integer as desired.

Leader—Motivation Score:

This aggregate score will be formed based on responses to the last 5 questions from the team (excluding the leader's responses), and in an almost identical way as the previous score. To compute this score, the team members' responses (at a given timepoint) will be aggregated following this algorithm:

For each question, take a standard average of all team member's scores to create a single score for each of the 5 questions, resulting in 5 scores (these will be denoted as LDi where i={6, 7, 8, 9, 10} and i represents the question number).

For example, if there are 3 team members in the team (excluding the leader), and each of their scores are 67, 70 and 82 for question 6, then the LD6 term can be computed as:

(67+70+82)/3= [symbol] LD [symbol] _6=73

This is repeated for each of the other questions 7-10 to obtain LD7, LD8, etc. Although a non-integer LDi may be obtained, it is best to avoid rounding them.

With our LDi set (where i={6, 7, 8, 9, 10}), the aggregation of these together form a “Motivation/Inspire Score”. The aggregation will initially be of the form:

w_6* [symbol] LD [symbol] _6+w_7* [symbol] LD [symbol] _7+w_8* [symbol] LD [symbol] _8+w_9* [symbol] LD [symbol] _9+w_10*

[symbol] LD [symbol] _10=Motivation/Inspire Score with
6. I inspire my team members to do the best they can.
7. I ensure that my team members have the skills to succeed.
8. I help my team members to learn from their mistakes, and move forward.
9. I provide my team with resources so they can do their jobs well.
10. I promote team interactions that result in trust, transparency, and open dialogue.

wi (for i={6, 7, 8, 9, 10}) corresponding to the weights of our aggregation. For a standard average, then wi=(⅕) to ensure that the sum of all wi is 1. However, there are two additional elements that may be incorporated into the aggregation as discussed in the meeting: (1) outlier penalization (increased weighting for low LDi) and (2) doubling the weight to Question 10 “Facilitates team interactions that result in trust, transparency, and open dialogue”. To simplify specifying the weights while incorporating these two elements, conduct the following on the weights:

For i={6, 7, 8, 9}, set the wi=1

For i=10, set wi=2

For any 65≤LDi<70, multiply the corresponding wi by 1.5

For any LDi<65, multiply the corresponding wi by 2

Take the sum of all wi (wsum) and divide each wi by that sum to normalize the weights and ensure that their sum now equals 1.

Once the weights have been readjusted, you can then apply them (along with the previously computed LDi) to the above equation to compute the overall Motivation Score. This Motivation Score can then be rounded to the nearest integer as desired.

% Leader Effectiveness Score:

One the above “Competence Score” and “Motivation Score” are obtained, the computation of the “% Leader Effectiveness Score” is facilitated by taking the average of these two scores:

(Competence Score+Motivation Score)/2=% Leader Effectiveness Score.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above-described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions.

The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing.

A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

### Additional Description

Benefits: The Launch Kit is that it provides learners with a seamless onboarding experience, taking the weight off of the buyer; It is professional, clean, and digestible to understand.

Benefits: By having learners sign the Participant Agreement before the program begins, this allows for Vivo Team to hold learners accountable throughout the program, as they agreed to participate in the way that the system has outlined for them. This is critical for buyers, who can also use the Participant Agreement to hold their employees accountable.

This method specializes in both science and performance: participants get specific, direct feedback on actual workplace issues. Collaboration grows through experiential (vs. theoretical) learning.

The system applies tactics and strategies immediately to ensure the training sticks.

How The System Trains Coaches:

When working with Vivo Team, our coaches first start with an intensive onboarding process that outlines: Training Deal+NDA; Zoom Competency Check; Completing Vivo Team's VSR; Vivo Team Brand Story—Values, Vision, Mission; Read eBook 1: Leadership for Einstein's Executive Summary—A Taste of Genius; Read eBook 2: Accountability; Review Vivo Team's Key Models: Leadership for Einstein's Model; Leadership for Einstein's Steps; 6 Steps to Painless Accountability Improvement; The Video Test; Six Stages of Team Development; The Communication Loop; The 5 Ingredients of Emotional Intelligence; The Feedback Matrix Self-Assessment; The Feedback Matrix; The Interactive Feedback; The DOSE; and Complete Vivo Team's How to Shine Online! Course.

Reviews instructor-led and group coaching recordings to ensure training is aligned with client objectives and is relevant to participants.

Team & Manager Transfer: To encourage the application of the learning for the leaders, summary videos are shared (3-5 minutes of what was covered in the session) and Hot Sheets with all of the leader's direct reports and their manager.

Net Promoter Score. The goal is to have 80%-100% of participants choosing to recommend the program—this scoring system is custom to programming in the L&D space. Our current recommendation percentage from 2021+2022 is 97%.

Future Features include, but are not limited to, Continuous learning and development planning; learning highlights testimonials, related VSRs, ROI; executive themes and review.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A computer program comprising instructions which, when the program is executed by a computer, cause the computer to carry out the steps comprising of:
calculating, using the computer program, a baseline cost of lost productivity of a team;
providing a training program for the team having a leader to participate, comprising:
a vital statistics report, using the computer program, the vital statistics report having a key indicator; and
a statement, using the vital statistics report, is displayed to the team, wherein the statement is associated with the key indicator, wherein the team responds with a response to the statement, the response forms a score;
computing the score, using machine learning, to calculate a measured cost of lost productivity of the team; and
comparing the baseline cost of the lost productivity of the team to the measured cost of the lost productivity of the team, using the computer program, to generate a team effectiveness score based on detected behavioral changes that determine effectiveness of the team.

2. The computer program of claim 1 wherein, the key indicator is communication.

3. The computer program of claim 1 wherein, the key indicator is accountability.

4. The computer program of claim 1 wherein, the key indicator is interactive feedback.

5. The computer program of claim 1 wherein, the key indicator is emotional intelligence.

6. The computer program of claim 1 wherein, the key indicator is structures.

7. The computer program of claim 1 wherein, the key indicator is cohesion.

8. The computer program of claim 1 wherein, the statement being competency based.

9. The computer program of claim 1 wherein, the statement being motivation based.

10. The computer program of claim 1 wherein, the statement being collaboration based.

11. The computer program of claim 1 wherein, the baseline cost is determined before a training session begins during diagnosis.

12. The computer program of claim 1 wherein, the training program uses a spaced learning model having a plurality of training sessions with at least one interval of no learning.

13. The computer program of claim 1 further comprising the training program uses analytics being a data set that describes a meaningful pattern of human behavior in the team having the leader, wherein predicting of probable consequences and prescribing of a solution to a potentially negative behavior is performed during the training program.

14. The computer program of claim 1 wherein, the team effectiveness score and a measure of the cost of the lost productivity is represented in a monetary value, using the computer program.
